(19) United States
(12) Patent Application Publication
(10) Pub. No.: US 2008/0198303 A1
(43) Pub. Date: Aug. 21, 2008

(54) Polarizing plate and liquid crystal display device

(75) Inventor: Keiichi Taguchi, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/007,971

(22) Filed: Jan. 17, 2008

(30) Foreign Application Priority Data
Jan. 18, 2007 (JP) 2007-008870

(51) Int. Cl. G02B 5/30; G02F 1/1335

(52) U.S. Cl. 349/96; 359/485

(57) ABSTRACT

A polarizing plate comprising at least a polarizing film and an optical film is disclosed. The polarizing plate has a transmittance through a pair of crossed polarizing plates equal to or less than 0.3% at 700 nm and a transmittance through a pair of crossed polarizing plates equal to or less than 0.1% at 410 nm; and the optical film has at least one optical axis in the plane thereof, and its in-plane retardation Re decreases with a shorter wavelength within a visible light range or is constant with a wavelength within a visible light range.

### CROSS-REFERENCE TO RELATED APPLICATIONS

This application claims benefit of priority under 35 U.S.C. 119 to Japanese Patent Application No. 2007-008870 filed Jan. 18, 2007, and the entire contents of the application are incorporated herein by reference.

### BACKGROUND OF THE INVENTION

1. Field of the Invention

The present invention relates to a polarizing plate that can contribute to improving the display performance of liquid-crystal display devices, and relates to a liquid-crystal display device comprising it.

2. Related Art

A liquid crystal display device (LCD) has been more and more widely used instead of a CRT, because it has a thin shape, lightweight and small electric power consumption. Various LCD modes employing a liquid crystal cell in which liquid crystal molecules are aligned in any alignment state have been proposed. Among these, the 90 degree-twisted nematic cell, TN cell, is the most widely used LC cell.

In general, a liquid crystal display device comprises a liquid crystal cell, an optical compensation sheet and a polarizing element. The optical compensation sheet is used for reducing coloration on the images or widening the viewing angles, and stretched birefringent films or films having a coated liquid crystal layer thereon are utilized. For example, as an optical compensation film capable of widening the viewing angles of a TN mode LCD, an optical compensation sheet prepared by fixing discotic liquid crystal in an alignment state on a cellulose acylate film is proposed. However, the viewing angle properties required for large-screen LCD televisions, which may be viewed in various directions, are so tough that they cannot be achieved by employing such the optical compensation sheet. And various modes such as IPS (In-Plane Switching), OCB (Optically Compensatory Bend) and VA (Vertically Aligned) modes other than the TN-mode have been researched and developed. Especially, the VA mode can achieve high contrast and good productivity, and LCDs employing the VA mode have been developed as televisions.

A VA mode realizes almost complete black state in the normal direction of the panel thereof, but is problematic in that when its panel is viewed in an oblique direction, then there occurs light leakage and the viewing angle is narrowed. To solve this problem, proposed is use of an optically-biaxial retardation film of which the refractive index differs in three directions, thereby improving the viewing angle characteristics of VA modes (for example, JPA No. 2003-344856).

However, the above-mentioned method is for reducing the light leakage only within a limited wavelength range (for example, green light at around 548 nm), in which nothing is taken into consideration for light leakage in the other wavelength range (for example, blue light at around 446 nm, red light at around 650 nm). Therefore, when the panel is viewed in an oblique direction in a black state, then there occurs a problem of color shift to blue or red coloration. As a means for solving this problem, proposed is a method of using two retardation films having specific wavelength dispersion characteristics of the retardation (Japanese Patent No. 3648240).

However, for satisfying the recent requirements for higher display quality in the art, desired is further quality improvement relative to the above-mentioned problems.

Also proposed is providing a polarizing plate that satisfies specific characteristics for improving the display characteristics of liquid-crystal display devices in terms of hue and viewing angle characteristics thereof (JPA No. 2006-39516).

### SUMMARY OF THE INVENTION

One object of the present invention is to provide a polarizing plate which can contribute to widening viewing angles and reducing color shift in the normal and oblique directions, and to provide a liquid-crystal display device which has wide viewing angle characteristics, of which color shift in the normal and oblique directions is reduced, and which achieves a neutral black state in any directions.

In one aspect, the invention provides a polarizing plate comprising at least a polarizing film and an optical film, and

having a transmittance through a pair of crossed polarizing plates equal to or less than 0.3% at 700 nm and a transmittance through a pair of crossed polarizing plates equal to or less than 0.1% at 410 nm,

wherein the optical film has at least one optical axis in the plane thereof, and its in-plane retardation Re decreases with a shorter wavelength within a visible light range or is constant with a wavelength within a visible light range.

As embodiments of the invention, there are provided the polarizing plate having the degree of polarization P, as defined by the following formula, equal to or more than 99.95%:

Degree of polarization P=[(H0−H1)/(H0+H1)]^{1/2}×100 (1)

provided that H0 means the transmittance (%) through a pair of parallel polarizing plates and H1 means the transmittance (%) through a pair of crossed polarizing plates;

the polarizing plate which has a thickness equal to or less than 28 μm;

the polarizing plate wherein the optical film satisfies the following relations (a1) to (a6):

Re(548)>20 nm (a1)

0.5<Nz<10 (a2)

Re(446)/Re(548)≦1

1≦Re(628)/Re(548) (a4)

Rth(446)/Rth(548)≦1 (a5)

1<Rth(628)/Rth(548) (a6)

provided that Re(λ) and Rth(λ) each mean the in-plane and thickness-direction (unit: nm) of the film, as measured with light having a wavelength of λ nm applied thereto, and Nz=Rth(548)/Re(548)+0.5; and

the polarizing plate, wherein the optical film further satisfies the following relations (7a) to (9a):

−2.5×Re(548)+300<Rth(548)<−2.5×Re(548)+500 (7a)

−2.5×Re(446)+250<Rth(446)<−2.5×Re(446)+450 (8a)

−2.5×Re(628)+350<Rth(628)<−2.5×Re(628)+550. (9a)

The optical film may be a cellulose acylate film, and the cellulose acylate film may comprise an Re enhancer. The Re enhancer may comprise at least one compound represented by formula (I):

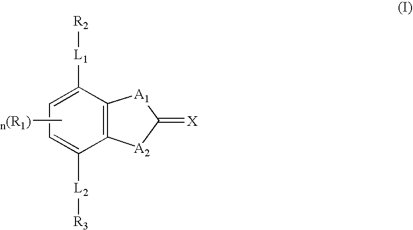

where, L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

The Re enhancer may comprise at least two types of compounds.

The polarizing plate of the invention may have a width equal to or more than 1420 mm and/or may have a length equal to or more than 2000 m. The thickness of the optical film may be from 30 to 200 μm.

The polarizing plate of the invention may further comprise a protective film on the surface of the polarizing film opposite to the surface thereof on which the optical film is disposed. The degree of moisture−permeation of the protective film is preferably equal to or less than 300 g/(m²·day). The protective film may be a norbornene polymer film.

In another aspect, the invention provides a liquid-crystal display device comprising a polarizing plate of the invention, a liquid-crystal cell, and an optically-anisotropic layer satisfying the following relations (b1) and (b2):

|Rth(548)/Re(548)|>10 (b1)

Rth(628)−Rth(446)<0. (b2)

As embodiments of the invention, there are provided the liquid-crystal display device wherein the optically-anisotropic layer is a cellulose acylate film; the liquid-crystal display device wherein the cellulose acylate film comprises an Rth enhancer; the liquid-crystal display device wherein the Rth enhancer comprises at lease one compound having an absorption peak at a wavelength within the range from 250 to 380 nm; the liquid-crystal display device wherein the optically-anisotropic layer is or comprises a layer formed of a liquid crystal composition; and the liquid-crystal display device wherein the liquid-crystal cell is a vertical alignment-mode liquid-crystal cell.

### BRIEF DESCRIPTION OF THE DRAWINGS

FIG. 1 is a schematic cross-sectional view of one example of a polarizing plate of the invention.

FIG. 2 is a schematic cross-sectional view of one example of a liquid-crystal display device of the invention.

FIG. 3 is a view used for explaining one example of the optical compensatory mechanism of a liquid-crystal display device the invention, on a Poincare sphere.

FIG. 4 is a view used for explaining one example of the optical compensatory mechanism of a liquid-crystal display device the invention, on a Poincare sphere.

FIG. 5 is a view used for explaining one example of the optical compensatory mechanism of a liquid-crystal display device the invention, on a Poincare sphere.

In the drawings, the reference numerals and signs have the following meanings:
11, 12 Polarizing Film
13 Liquid-Crystal Cell
14 Optical Film (first optically-anisotropic layer)
15 Second Optically-Anisotropic Layer
16, 17 Protective Film
P1 Backlight Side Polarizing plate (polarizing plate of the invention)
P2 Displaying Side Polarizing plate

### DETAILED DESCRIPTION OF THE INVENTION

The invention is described hereinunder. In this description, the numerical range expressed by the wording “a number to another number” means the range that falls between the former number indicating the lowermost limit of the range and the latter number indicating the uppermost limit thereof. The term “substantially perpendicular or parallel” is meant to include a range of exact angle ±10°.

In this description, Re (λ) and Rth (λ) are an in-plane retardation (nm) and a thickness-direction retardation (nm), respectively, at a wavelength of λ. Re(λ) is measured by applying light having a wavelength of λ nm to a film in the normal direction of the film, using KOBRA 21ADH or WR (by Oji Scientific Instruments).

When a film to be analyze by a monoaxial or biaxial index ellipsoid, Rth(λ) of the film is calculated as follows. Rth(λ) is calculated by KOBRA 21ADH or WR based on six Re(λ) values which are measured for incoming light of a wavelength λ nm in six directions which are decided by a 100 step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (21) and (22):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 21 )$$

Rth={(nx+ny)/2−nz}×d

wherein Re (θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In this description, Re(λ) and Rth(λ) such as Re(446), Re (548), Re(628), Rth(446), Rth(548) and Rth(628) are measured as follows: Using a measuring instrument, a sample is analyzed at three or more different wavelengths (for example, λ=479.2, 546.3, 632.8, 745.3 nm), and Re and Rth of the sample are calculated at those wavelengths. The data are approximated according to a Cauchy's formula (up to the trinominal expression, Re=A+B/λ²+C/λ⁴), to obtain the values A, B and C. From the above, Re and Rth at a wavelength λ are plotted, and Re and Rth at the wavelength λ are obtained as Re(λ) and Rth(λ).

### [Polarizing Plate]

The polarizing plate of the invention comprises at least a polarizing film and an optical film. And the polarizing plate has a transmittance through a pair of crossed polarizing plates equal to or less than 0.3% at 700 nm and a transmittance through a pair of crossed polarizing plates equal to or less than 0.1% at 410 nm. And the optical film has at least one optical axis in the plane thereof and its in-plane retardation Re decreases with a shorter wavelength within a visible light range or is constant with a wavelength within a visible light range.

The polarizing plate of which transmittance at 700 nm and 410 nm through a pair of crossed polarizing plates (in a cross-Nicol configuration) falls within the above range may comprise a polarizing film produced in a condition, for example, as follows:

a stretching process is carried out with a high stretching ratio, a dyeing process is carried out with a dyeing solution containing a dichroic substance in a high concentration, or

a dyeing process and/or a hardening process is carried out with a dyeing solution and/or a hardening solution containing any hue-controlling agent together with a dichroic substance.

Preferred conditions and methods are described in detail in the section of examples of production method for polarizing plate given hereinunder.

Preferably, the polarizing plate of the invention has a degree of polarization P, as defined by the following formula (1), of at least 99.95%. Having the degree of polarization P that falls within the range, the polarizing plate is favorable as improving the contrast of liquid-crystal display devices.

Degree of polarization P=[(H0−H1)/(H0+H1)]^{1/2}×100 (1)

In this, H0 means the transmittance (%) through a pair of parallel polarizing plates and H1 means the transmittance (%) through a pair of crossed polarizing plates. Or that is, H0 means the transmittance (%) when two polarizing plates are placed one upon another in a manner that their absorption axes are parallel to each other and H1 means the transmittance (%) when two polarizing plates are placed one upon another in a manner that their absorption axes are perpendicular to each other.

The degree of polarization P may be measured, for example, using Shimadzu auto spectrophotometer UV3100. The degree of polarization may be obtained from the above formula (I) in which H0(%) is the transmittance through a pair of parallel polarizing plates, and H1(%) is the transmittance through a pair of crossed polarizing plates.

### (Polarizing Film)

Not specifically defined, the material for the polarizing film of the polarizing plate of the invention may be any one satisfying the above-mentioned condition for the polarizing plate. Various polymers may be used, and above all, polyvinyl alcohol (PVA) is preferred. PVA is prepared by saponifying polyvinyl acetate, and for example, it may contain a component copolymerizable with vinyl acetate such as unsaturated carboxylic acid, unsaturated sulfonic acid, olefin, vinyl ether. Also usable is modified PVA that contains an acetoacetyl group, a sulfonic acid group, a carboxyl group, an oxyalkylene group.

Not specifically defined, the degree of saponification of PVA for use in producing the polarizing film is preferably from 80 to 100 mol %, more preferably from 90 to 100 mol % in terms of solubility of the polymer. Also not specifically defined, the degree of polymerization of PVA is preferably from 1000 to 10000, more preferably from 1500 to 5000.

The PVA film is preferably prepared by casting a fluid prepared by dissolving PVA in water or an organic solvent. The PVA concentration in the fluid is generally from 5 to 20% by mass, and the fluid is formed into a film according to a casting method thereby to produce a PVA film having a thickness of from 10 to 200 μm. For the PVA film production, referred to are patent publications of Japanese Patent No. 3342516, JPA Nos. hei 09-328593, hei 13-302817, and hei 14-144401.

The degree of crystallinity of the PVA film used as the polarizing film in the invention is not specifically defined. For example, a PVA film having a mean degree of crystallinity (Xc) of from 50 to 75% by mass, as described in Japanese Patent No. 3251073, may be used. Also usable is a PVA film having a reduced degree of crystallinity of at most 38% of which the in-plane color shift is thereby reduced, as described in JPA No. hei 14-236214.

Preferably, the birefringence (Δn) of the PVA film is small. For example, preferred is a PVA film having a birefringence of at most as described in Japanese Patent No. 3342516. Also usable is a PVA film having birefringence within a range from 0.002 to 0.01 for obtaining a high degree of polarization with evading a trouble of PVA film breakage in stretching, as described in JPA No. 2002-228835.

Regarding the syndiotacticity of PVA, a PVA film having a syndiotacticity of at least 55% may be used for improving its durability, as described in Japanese Patent No. 2978219; or a PVA film having a syndiotacticity of from 45 to 52.5 mol % may be used, as described in Japanese Patent No. 3317494.

In addition, also favorably usable as the polarizing film are any of a PVA film having a 1,2-glycol bonding amount of at most 1.5 mol % as described in Japanese Patent No. 3021494; a PVA film in which the number of optical impurities of at least 5 μm in size is at most 500/100 cm², as described in JPA No. hei 13-316492; a PVA film having a hot water breakage temperature fluctuation in the direction TD of at most 1.5° C., as described in JPA No. hei 14-030163; and a PVA film formed from a solution mixed with a plasticizer in an amount of at least 15% by mass, as described in JPA No. hei 06-289225.

Preferably, the polarizing film is produced by processing the polymer film such as PVA film according to a process comprising a swelling process, dyeing process, hardening process and stretching process described hereinunder. The order of dyeing process, hardening process and stretching process may be changed in any desired manner, or some of those processes may be combined and may be carried out simultaneously.

The processing processes are described below.

### <<Swelling Process>>

First, a polymer film for polarizing film such as PVA film is contacted with water to be swollen. Preferably in the swelling process, water alone is used; but as in JPA No. hei 10-153709, the polymer film for polarizing film may be swollen in an aqueous boric acid solution, thereby controlling the degree of swelling of the polymer film for polarizing film for stabilizing the optical performance of the film and for preventing the polymer film for polarizing film from being wrinkled in the production line. The temperature and the time for the swelling process may be determined in any desired manner; but preferably, the temperature is from 10° C. to 50° C. and the time is at least 5 seconds (more preferably from 10 to 300 seconds).

### <<Dyeing Process>>

Next in the dyeing process, the polymer film for polarizing film is dyed with a dichroic substance such as iodine dye. The dyeing process may be carried out in any phase such as vapor-phase or liquid-phase adsorption. For example, usable is a method of dipping a polymer film for polarizing film in a dye liquid (solution of iodine or dye); or a method of coating or spraying a polymer film for polarizing film with a dye solution.

The dyeing process may be carried out before or after the stretching process; but preferably, it is carried out in a liquid phase before the stretching process as the film may be suitably swollen and may be readily stretched.

For carrying out the dyeing process in a liquid phase, iodine may be used as the dichroic substance, and in such a case, it is desirable that an aqueous solution of iodine-potassium iodide is used as the dyeing solution, and a film for polarizing film such as PVA film is dipped in it so as to be dyed. Preferably, iodine accounts for from 0.05 to 20 g/L, potassium iodide accounts for from 3 to 200 g/L, and the ratio by mass of iodine to potassium iodide is from 1 to 100. Preferably, the dyeing time is from 10 to 1200 seconds, and the liquid temperature is from 10 to 60° C. More preferably, iodine accounts for from 0.5 to 2 g/L, potassium iodide accounts for from 30 to 120 g/L, and the ratio by mass of iodine to potassium iodide is from 30 to 120; and more preferably, the dyeing time is from 30 to 600 seconds, and the liquid temperature is from 20 to 50° C. In the invention, in order that the polarizing plate may satisfy the above-mentioned predetermined condition, it is desirable that the iodine concentration in the dyeing solution to be used in the dyeing process is higher than ordinary. More preferably, the iodine concentration in the dyeing solution is at least 0.5 g/L, even more preferably at least 0.7 g/L.

Examples of the dichroic substance to be used in the dyeing process include iodine and various dichroic dyes. Examples of the dichroic dye usable for dyeing are described in JPA No. 2002-86554, column [0038]

In the dyeing process and in the hardening process to be mentioned below, the polymer film for polarizing film preferably contains a hue-controlling agent. Using a hue-controlling agent having an absorption within a predetermined wavelength range facilitates the fabrication of a polarizing film having a transmittance through a pair of crossed polarizing plates equal to or less than 0.3% at 700 nm and a transmittance through a pair of crossed polarizing plates equal to or less than 0.1% at 410 nm. Preferably, the hue-controlling agent for use herein is at least one yellow dye having an absorption maximum within a wavelength range from 380 to 480 nm, and/or at least one blue dye having an absorption maximum within a wavelength range from 600 to 700 nm; more preferably, the agent comprises both the two. Examples of the yellow dye, which has an absorption peak at a wavelength within the range, include C.I. direct yellow 44, C.I. direct yellow 12, C.I direct yellow 8, C.I. direct yellow 28, C.I. direct yellow 86, C.I. direct yellow 87, and C.I. direct yellow 142. Examples of the blue dye, which has an absorption peak at a wavelength within the range, include C.I. direct blue 1, C.I. direct blue 90, C.I. direct blue 22, C.I. direct blue 151, C.I. direct blue 15, C.I. direct blue 67, C.I. direct blue 71, C.I. direct blue 98, C.I. direct blue 168, C.I. direct blue 202, C.I. direct blue 236, C.I. direct blue 249 and C.I. direct blue 270.

The examples also include C.I. Direct dyes described in “Applications of Polarizing Film (HENKOH FILUMU NO OHYOH)” (published by CMC Feb. 10, 1986) and “COLOUR INDEX, Third Edition, Volume 2” (published by The Society of Dyers and Colourists, The American Association of Textile Chemists and Colrists in 1971). The dichroic dyes described in JPA Nos. syo 62-70802, hei 1-161202, hei 1-172906, hei 1-172907, hei 1-183602, hei 1-248105, hei 1-265205, hei 6-65815 and hei 7-261024 can also be used in the present invention preferably.

Preferably, the hue-controlling agent is added to the hardener to be used in the hardening process. The preferred amount of the hue-controlling agent to be added to the hardener may be determined depending on the type of the hue-controlling agent to be used, but in general, it is preferably from 0.001 to 10 g/L, more preferably from 0.01 to 1 g/L.

### <<Hardening Process>>

The hardening process is for hardening the polymer film for polarizing film such as PVA film with a crosslinking agent. This may be carried out simultaneously with the dyeing process and/or simultaneously with the stretching process. Concretely, the polymer film for polarizing film is dipped in a crosslinking agent solution, or a crosslinking agent solution is applied to it, whereby polymer film for polarizing film is impregnated with the crosslinking agent. As described in the above, the polymer film is preferably impregnated with any hue-controlling agent along with the crosslinking agent. In case where the polymer film for polarizing film is a PVA film, then the hardening agent (cross linking agent) is preferably a boron compound such as boric acid, borax. Preferably, boric acid is added in an amount of from 1 to 80 times, more preferably from 1 to 30 times by mass relative to the amount of iodine to be used in the dyeing process.

The condition for the hardening process is not specifically defined, and various conditions and various methods may be employed. For example, as described in JPA No. hei 11-52130, the hardening process may be carried out a few times, as divided. The crosslinking agent described in U.S. Reissue Pat. No. 232897 may be used. As in Japanese Patent No. 3357109, a polyaldehyde may be used as the crosslinking agent for improvement of dimensional stability.

As described in the above, in case where boric acid is used as the crosslinking agent in the hardening process, potassium iodide may be added to the hardening solution along with boric acid therein, thereby preparing an aqueous solution of boric acid/potassium iodide. A metal ion may be added to the aqueous solution of boric acid/potassium iodide. The metal ion is preferably zinc chloride; however, ad described in JPA No. 2002-35512, any other zinc salt such as zinc halide, e.g., zinc iodide, or zinc sulfate or zinc acetate may be used in place of zinc chloride.

A preferred example of the hardening process is a method of dipping a polymer film for polarizing film in a hardening solution that comprises from 1 to 100 g/L of boric acid, from 1 to 120 g/L of potassium iodide, from 0 to 10 g/L of the above-mentioned predetermined yellow dye, and from 0 to 10 g/L of the above-mentioned predetermined blue dye, for a hardening period of time of from 10 to 1200 seconds and at a bath temperature of from 10 to 60° C. More preferably, a polymer film for polarizing film is dipped in a hardening solution that comprises from 10 to 80 g/L of boric acid, from 5 to 100 g/L of potassium iodide, from 0 to 1 g/L of the above-mentioned predetermined yellow dye, and from 0 to 1 g/L of the above-mentioned predetermined blue dye, for a hardening period of time of from 3 to 600 seconds and at a bath temperature of from 20 to 50° C.

In the dyeing process and the hardening process, it is important to keep the amount of the additives in the liquid constant for maintaining the polarization performance of the processed film. In continuous production, it is desirable that iodine, potassium iodide, boric acid, hue-controlling agent and other additives are replenished in the dyeing process and the hardening process in carrying out the processes. For the replenishment, the components may be in any form of solution or solid; and in case where they are in a form of solution, thick replenishers may be prepared and may be replenished little by little when desired.

### <<Stretching Process>>

In the stretching process, the dyed polymer film for polarizing film is stretched in a predetermined direction so that it may develops polarization performance. The stretching condition is not specifically defined. For fabricating the polarizing plate that satisfies the above-mentioned requirements, it is desirable that the stretching ratio is higher than that found in conventional methods. Concretely, the stretching ratio is preferably 5 times higher, more preferably 5.5 times higher. The stretching method is preferably a monoaxial stretching method as in U.S. Pat. No. 2,454,515. An oblique stretching method with a tenter system may also be employed, as in JPA No. 2002-86554. As described in the above, the stretching process may be carried out simultaneously with the hardening process, and in such a case, the polymer film for polarizing film is stretched while dipped in a hardening solution.

After the stretching process, if desired, the polymer film for polarizing film may be dried in a drying process. The drying condition is not specifically defined, and the drying may be carried out under various conditions. For example, the condition described in JPA No. 2002-86554 may be employed. In general, the drying temperature is preferably not higher than 80° C., more preferably not higher than 70° C. The drying time may be generally from 30 seconds to 60 minutes.

The thickness of the polarizing film produced according to the above-mentioned process is not specifically defined. The thickness of the polarizing film may be determined depending on the thickness of the polymer film used for the polarizing film and on the stretching ratio. In the invention, the stretching ratio is preferably higher; and taking these into consideration, the thickness of the polarizing film is preferably at most 28 μm around, more preferably at most 26 μm around. In general, the lowermost limit of the thickness is not specifically defined; but the lowermost limit of the thickness of the film may be 10 μm around.

The polarizing film thus produced according to the above-mentioned process is stuck to an optical film satisfying the requirements mentioned below. Next, the optical film, or that is, the other constitutive element of the polarizing plate of the invention is described below.

### (Optical Film)

The polarizing plate of the invention comprises an optical film having at least one optical axis in the plane thereof. Its in-plane retardation Re decreases with a shorter wavelength within a visible light range or is constant with a wavelength within a visible light range. The optical film of the type contributes to improving the display characteristics, reducing the color shift, and improving the contrast in oblique directions. In the invention, use of an optical film of which in-plane retardation Re decreases with a shorter wavelength within a visible light range or is constant with a wavelength within a visible light range, preferably an optical film of which both Re and Rth decrease with a shorter wavelength within a visible light range, significantly reduces the color shift in oblique directions. Heretofore, as one example of optical compensation in a vertically aligned mode liquid-crystal cell, there is known optical compensation with a combination of a biaxial polymer film and a C-plate. In general, the property of many biaxial polymer films is that both their Re and Rth increase with a shorter wavelength within a visible light range. Employing a biaxial polymer film having such properties for optical compensation of a vertically aligned mode liquid-crystal cell, it is difficult to achieve ideal optical compensation for any of RGB in a visible light range, therefore resulting in color shift. According to the present invention, an optical film of which Re (preferably both Re and Rth) decreases with a shorter wavelength within a visible light range or is constant with a wavelength within a visible light range is used, thereby remarkably reducing the color shift in oblique directions.

Preferably, the optical film is a biaxial film, and concretely, the film preferably satisfies the following relations (a1) and (a2), more preferably the following relations (a1)′ and (a2)′:

Re(548)>20 nm (a1)

0.5<Nz<10 (a2)

Re(548)>30 nm (a1)′

1.5<Nz<10. (a2)′

In these relations, Nz=Rth(548)/Re(548)+0.5.

As described in the above, preferably, the optical film is a film of which both Re and Rth decrease with a shorter wavelength within a visible light range or are constant with a wavelength within a visible light range, and more preferably the film satisfies the following relations (a3) to (a6):

Re(446)/Re(548)≦1 (a3)

1≦Re(628)/Re(548) (a4)

Rth(446)/Rth(548)≦1 (a5)

1≦Rth(628)/Rth(548) (a6)

More preferably, it satisfies the following relations (a3)′ to (a6)′:

0.60≦Re(446)/Re(548)≦1 (a3)′

1≦Re(628)/Re(548)≦1.25 (a4)′

0.60≦Rth(446)/Rth(548)≦1 (a5)′

1≦Rth(628)/Rth(548)≦1.25. (a6)′

Further more preferably, it satisfies the following relations (a3)″ to (a6)″:

0.65≦Re(446)/Re(548)≦1 (a3)″

1≦Re(628)/Re(548)≦1.20 (a4)″

0.65≦Rth(446)/Rth(548)≦1 (a5)″

1≦Rth(628)/Rth(548)≦1.20 (a6)″

Even further more preferably, it satisfies the following relations (a3)′″ to (a6)′″:

0.70≦Re(446)/Re(548)≦1 (a3)′″

1≦Re(628)/Re(548)≦1.15 (a4)′″

0.70≦Rth(446)/Rth(548)≦1 (a5)′″

1≦Rth(628)/Rth(548)≦1.15 (a6)′″

Still much more preferably, the optical film satisfies the following relations (7a) to (9a), as more significantly reducing the color shift in oblique directions.

−2.5×Re(548)+300<Rth(548)<−2.5×Re(548)+500 (7a)

−2.5×Re(446)+250<Rth(446)<−2.5×Re(446)+450 (8a)

−2.5×Re(628)+350<Rth(628)<−2.5×Re(628)+550. (9a)

### <<Polymer Material for Optical Film>>

The material for the optical film is not specifically defined so far as it satisfies the above-mentioned requirements. The material of the optical film is preferably a polymer having good optical properties, transparency, mechanical strength, thermal stability, water shieldability and isotropic properties; however, any material satisfying the above-mentioned requirements may be employed herein. For example, it includes polycarbonate-type polymer, polyester-type polymer such as polyethylene terephthalate and polyethylene naphthalate, acrylic polymer such as polymethyl methacrylate, and styrenic polymer such as polystyrene and acrylonitrile/styrene copolymer (AS resin). In addition, also employable are polyolefin-type polymer, for example, polyolefin such as polyethylene and polypropylene, and ethylene/propylene copolymer; vinyl chloride-type polymer; amide-type polymer such as nylon and aromatic polyamide; imide-type polymer, sulfone-type polymer, polyether sulfone-type polymer, polyether-ether ketone-type polymer, polyphenylene sulfide-type polymer, vinylidene chloride-type polymer, vinyl alcohol-type polymer, vinyl butyral-type polymer, arylate-type polymer, polyoxymethylene-type polymer, epoxy-type polymer; and mixed polymer of the above polymers.

As the material to form the polymer film, preferably used is a thermoplastic norbornene-type resin. Examples of the thermoplastic norbornene-type resin include Nippon Zeon's Zeonex and ZEONOR, and JSR's Arton, etc.

As the material to form the polymer film, especially preferred is a cellulose polymer heretofore used as a transparent protective film for polarizer (hereinafter this may be referred to as cellulose acylate). One typical example of cellulose acylate is triacetyl cellulose. Examples of the cellulose material for cellulose acylate include cotton liter and wood pulp (hardwood pulp, softwood pulp), and cellulose acylate obtained from any such cellulose material is usable herein. As the case may be, those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein. There should not be any specific limitation to the cellulose acylate film for use in the invention.

Regarding the degree of acyl substitution of the cellulose acylate for the cellulose acylate film for the first optically anisotropic layer, the cellulose acylate may have an acetyl group alone, or may be a composition of cellulose acylates having plural acyl substituents. As preferred examples of the cellulose acylate, the degree of total acylation may be from 2.3 to 3.0, preferably from 2.4 to 2.95, more preferably from 2.5 to 2.93.

As the acyl substituent for the cellulose acylate, also preferred is a mixed fatty acid ester. Preferably, the aliphatic acyl group of the fatty acid ester residue have from 2 to 20 carbon atoms. Concretely, the group includes acetyl, propionyl, butyryl, isobutyryl, valeryl, pivaloyl, hexanoyl, octanoyl, lauroyl, stearoyl; and preferred are acetyl, propionyl and butyryl.

The cellulose acylate may be a mixed acid ester having a fatty acid acyl group and a substituted or unsubstituted aromatic acyl group.

The degree of substitution with an aromatic acyl group in a cellulose fatty acid monoester is preferably at most 2.0, more preferably from 0.1 to 2.0 relative to the remaining hydroxyl group. In a cellulose fatty acid diester (cellulose diacetate), it is preferably at most 1.0, more preferably from 0.1 to 1.0 relative to the remaining hydroxyl group.

Preferably, the cellulose acylate has a mass-average degree of polymerization of from 350 to 800, more preferably from 370 to 600. Also preferably, the cellulose acylate for use in the invention has a number-average molecular weight of from 70000 to 230000, more preferably from 75000 to 230000, even more preferably from 78000 to 120000.

The cellulose acylate may be produced, using an acid anhydride or an acid chloride as the acylating agent for it. One most general production method on an industrial scale comprises esterifying cellulose obtained from cotton linter, wood pulp or the like with a mixed organic acid component containing an organic acid corresponding to an acetyl group and other acyl group (acetic acid, propionic acid, butyric acid) or its acid anhydride (acetic anhydride, propionic anhydride, butyric anhydride).

The cellulose acylate film is preferably produced according to a solvent-casting method. Examples of production of cellulose acylate film according to a solvent-casting method are given in U.S. Pat. Nos. 2,336,310, 2,367,603, 2,492,078, 2,492,977, 2,492,978, 2,607,704, 2,739,069 and 2,739,070, British Patent Nos. 640731 and 736892, JPB Nos. syo 45-4554 and syo 49-5614, and JPA Nos. syo 60-176834, syo 60-203430 and syo 62-115035, and their descriptions are referred to herein. The cellulose acylate film may be stretched. Regarding the method and condition for stretching treatment, for example, referred to are JPA Nos. syo 62-115035, hei 4-152125, hei 4-284211, hei 4-298310 and hei 11-48271.

### <<Re Enhancer>>

For preparing a cellulose acylate film satisfying the condition required for the optical film, an Re enhancer may be added to the cellulose acylate film. It is noted that the term “Re enhancer” is used for any compounds capable of developing or enhancing birefringence in the film plane.

The cellulose acylate film to be used as the optical film may comprise at least one compound represented by the formula (I) as an Re enhancer.

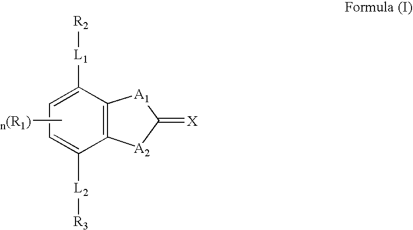

In the formula, L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

Among the compounds represented by the formula (I), the compounds represented by the formula (II) are preferred as a retardation enhancer.

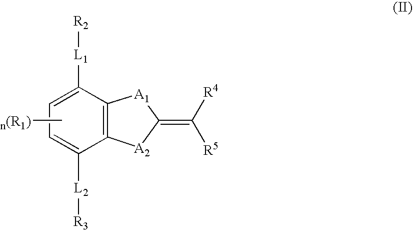

In the formula (II), L¹ and L² independently represent a single bond or a divalent group. A¹ and A² independently represent a group selected from the group consisting of —O—, —NR— where R represents a hydrogen atom or a substituent, —S— and —CO—. R¹, R² and R³ independently represent a substituent. And n is an integer from 0 to 2.

Preferred examples of the divalent linking group represented by L¹ or L² in the formula (I) or (II) include those shown below.

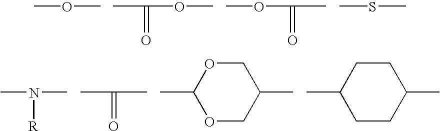

And further preferred are —O—, —COO— and —OCO—.

In the formulae (I) and (II), R¹ represents a substituent, if there are two or more R, they may be same or different from each other, or form a ring. Examples of the substituent include those shown below.

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo[1,2,2]heptane-2-yl and bicyclo[2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N—(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl) carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, an alkoxy group, an acyloxy group, cyano or an amino group; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵ independently represent a substituent. Examples of the substituent include those exemplified above as examples of R¹. Preferably, R⁴ and R⁵ independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity-(Hammeto soku-Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)” on p. 217, published by TOKYO KAGAKU DOZIN CO. LTD., and written by Tadao Nakatani; and Chemical Reviews, Vol. 91, No. 2, pp. 165-195 (1991).

In the formula, A¹ and A² independently represent a group selected from the group consisting of —O—, —NR— where R represents a hydrogen atom or a substituent, —S— and —CO—; and preferably, —O—, —NR— where R represents a substituent selected from those exemplified above as examples of R, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (I) or (II) include, but examples of the Re enhancer are not limited to, those shown below. Regarding the compounds shown below, each compound to which is appended (X) is referred to as “Example Compound (X)” unless it is specified.

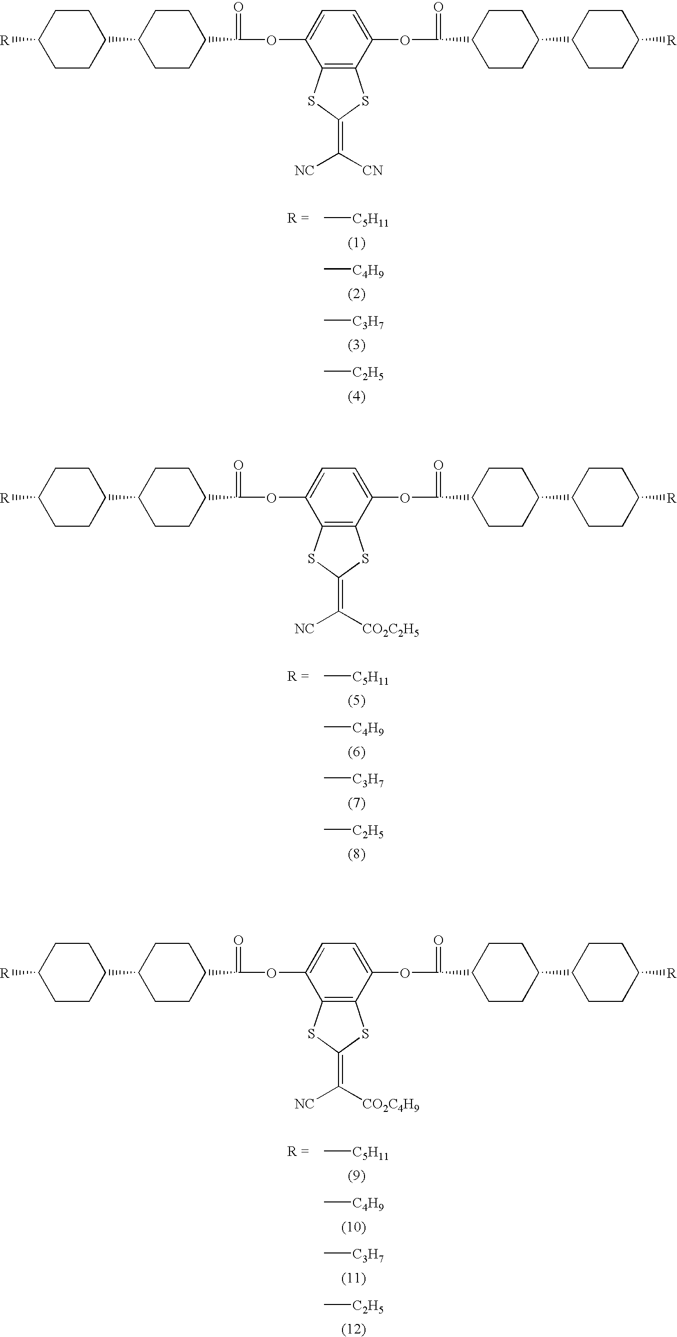

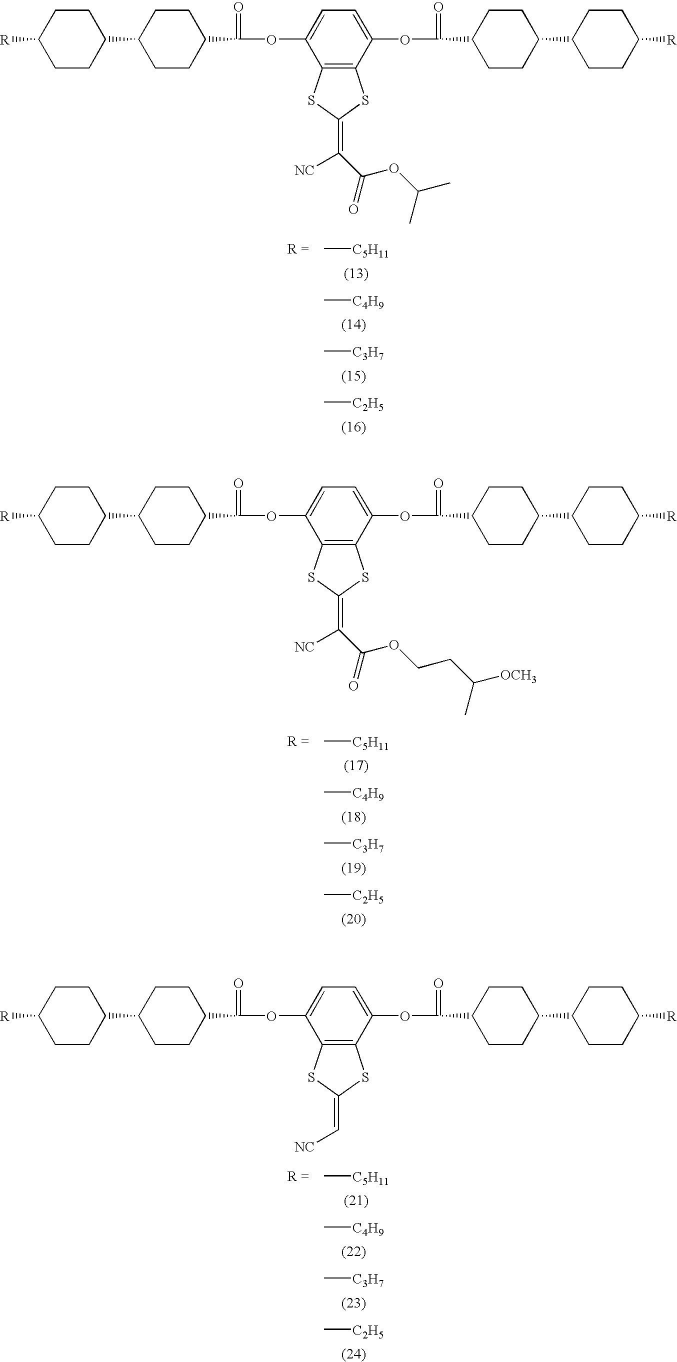

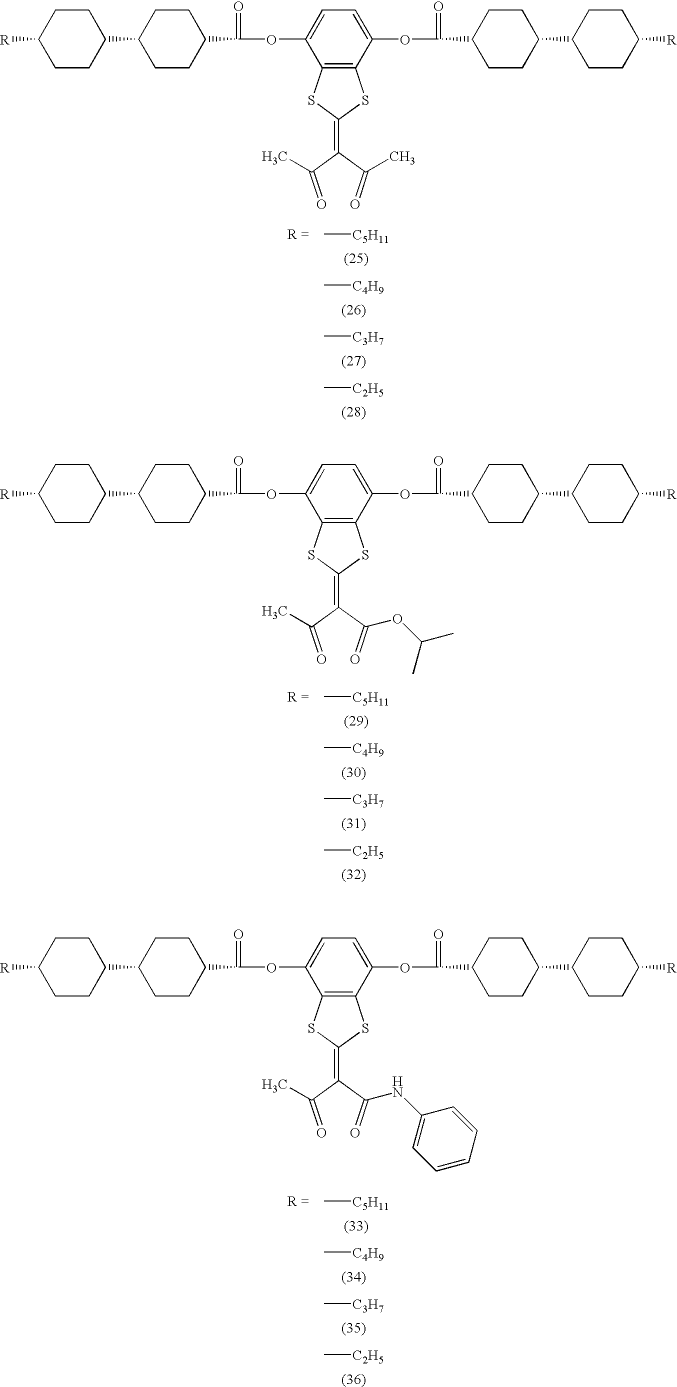

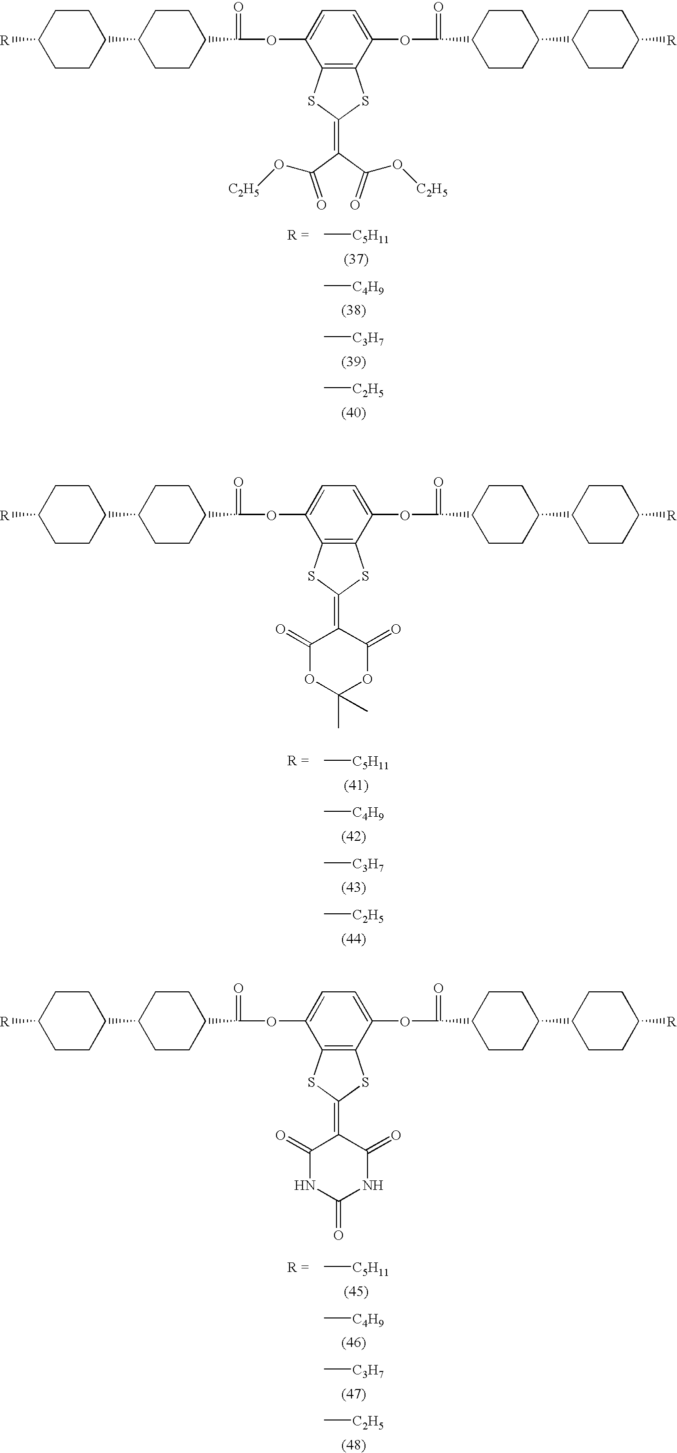

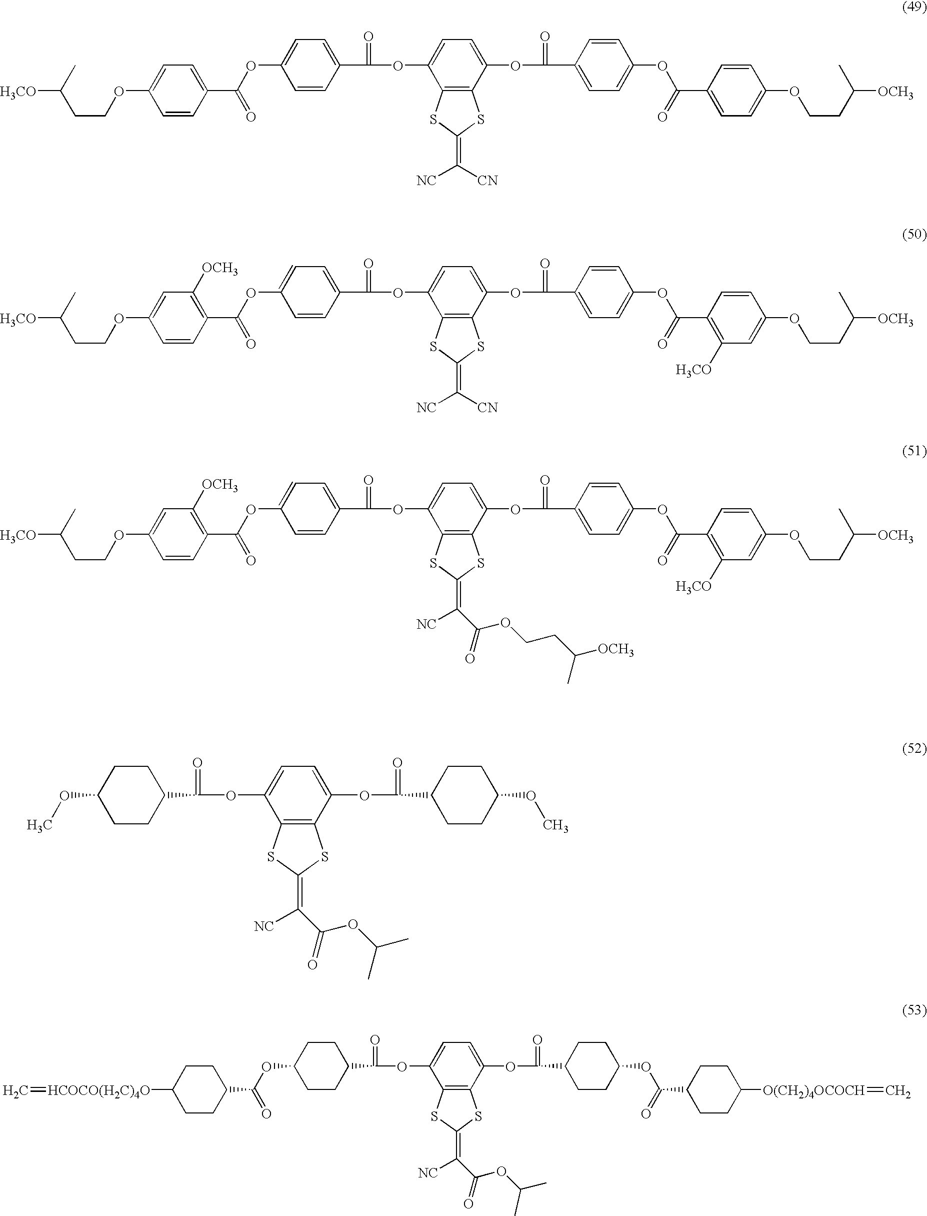

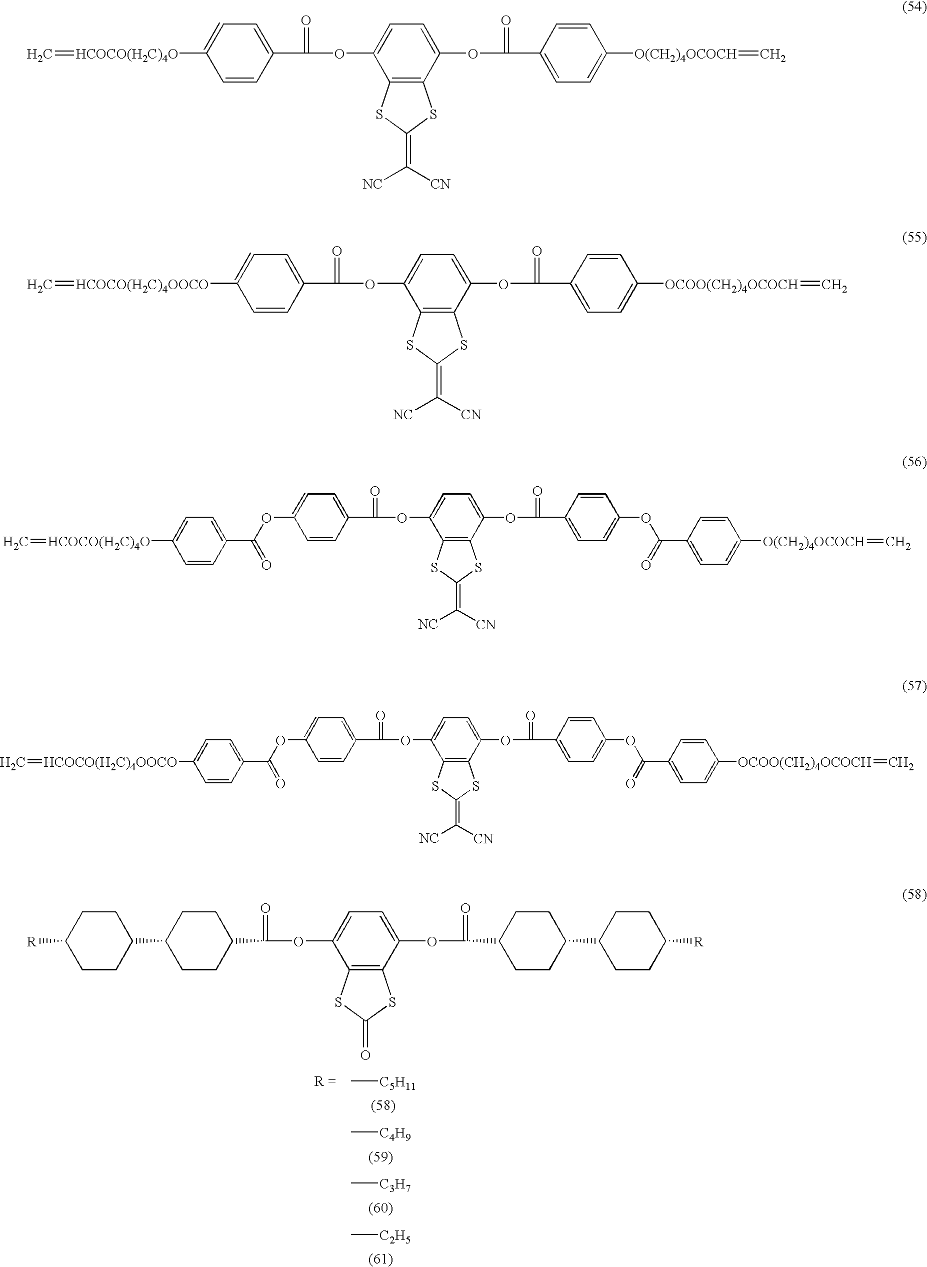

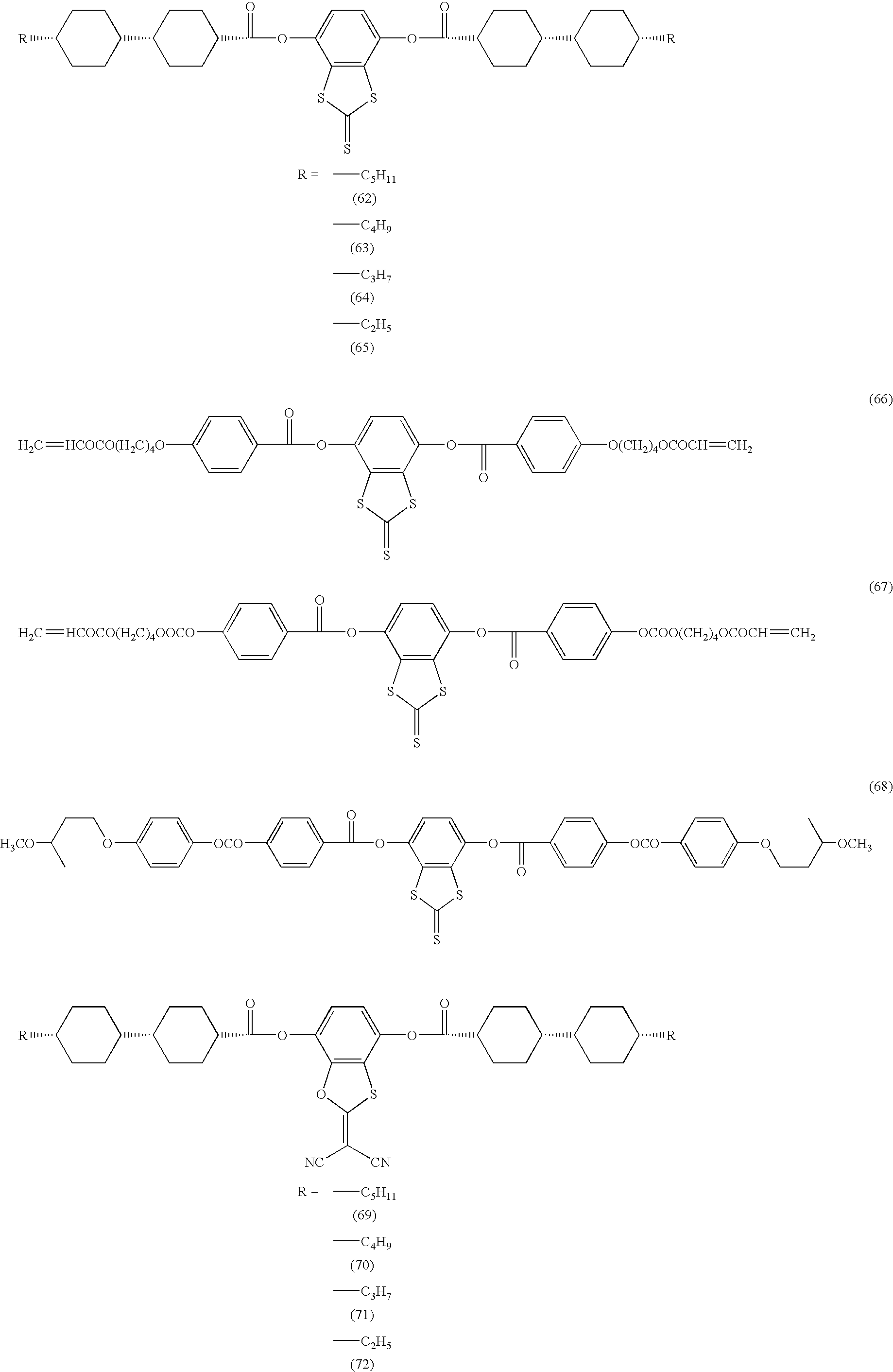

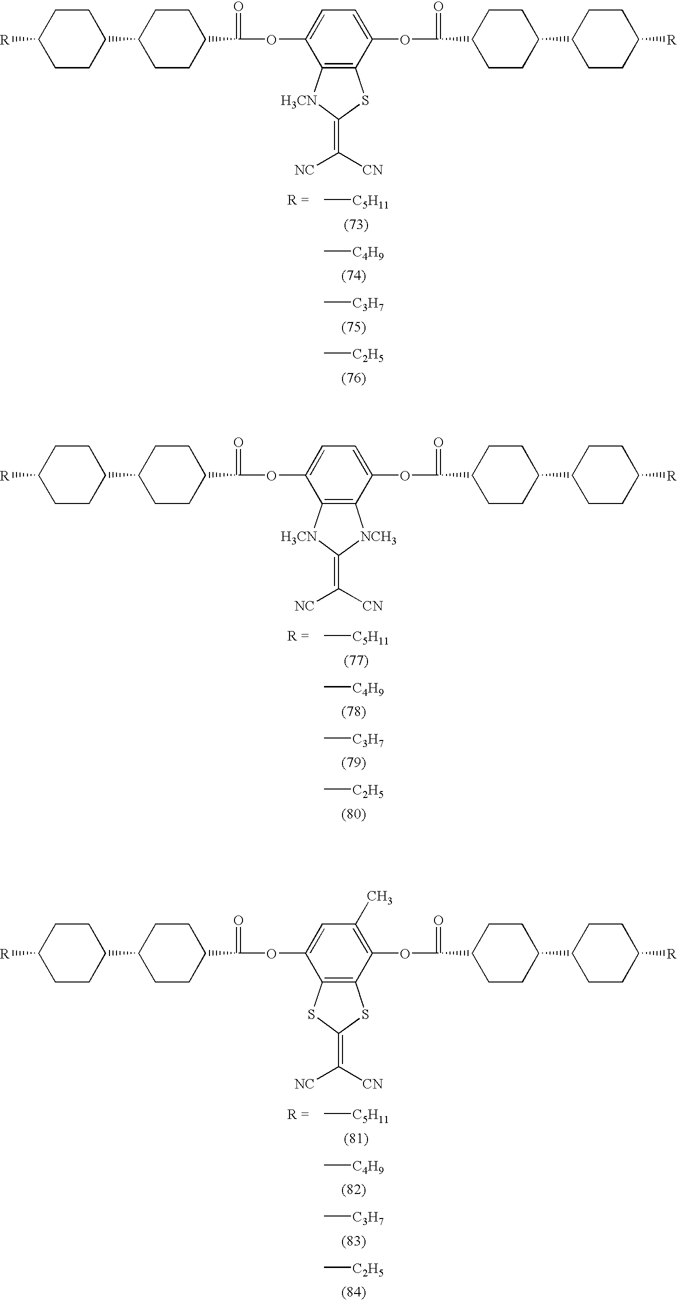

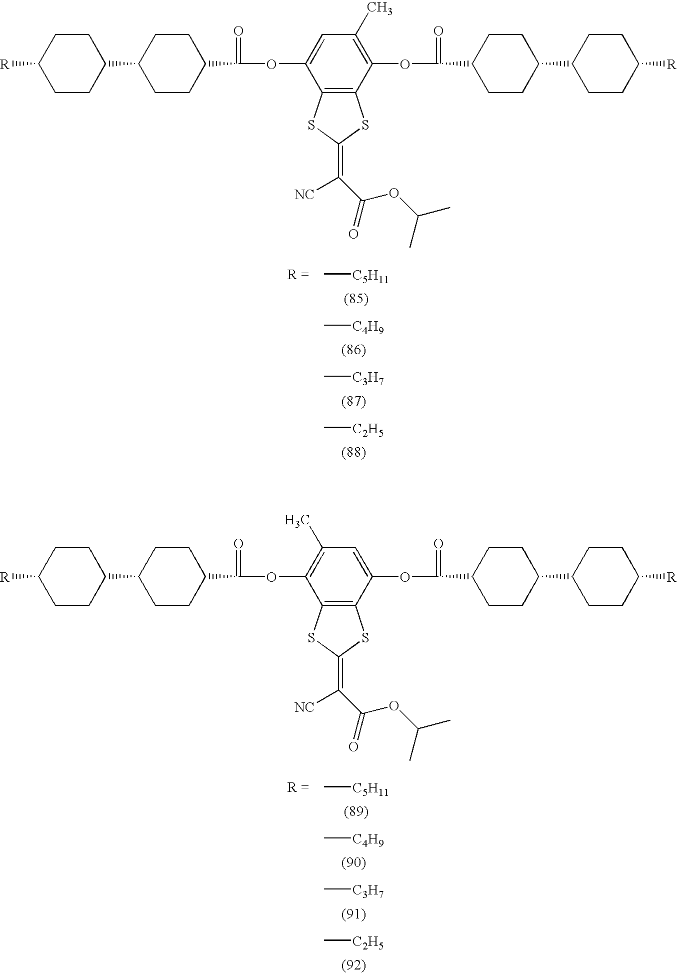

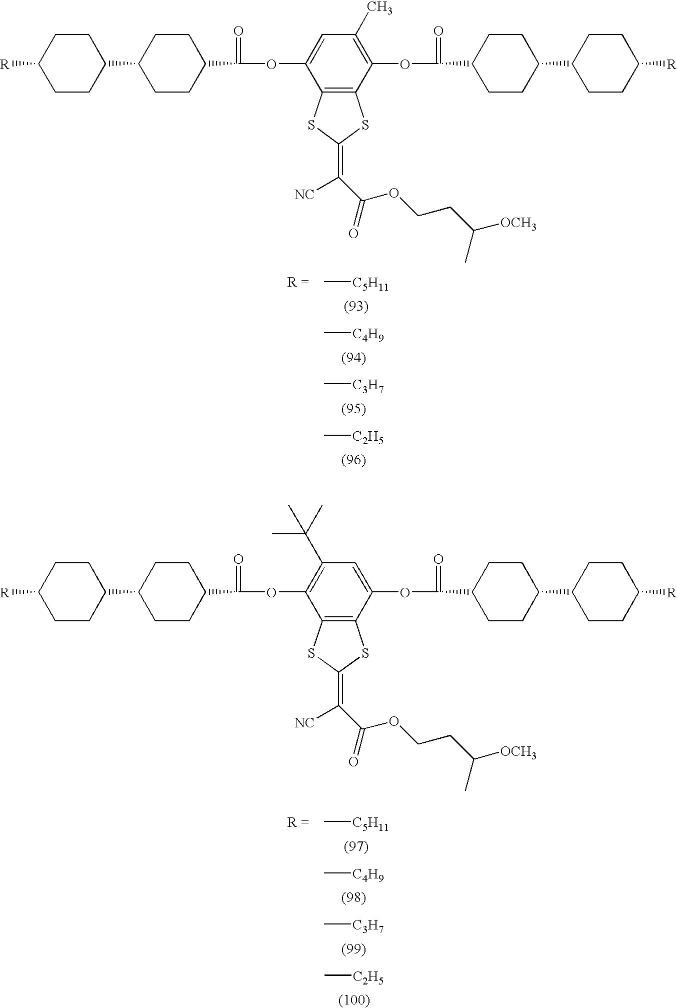

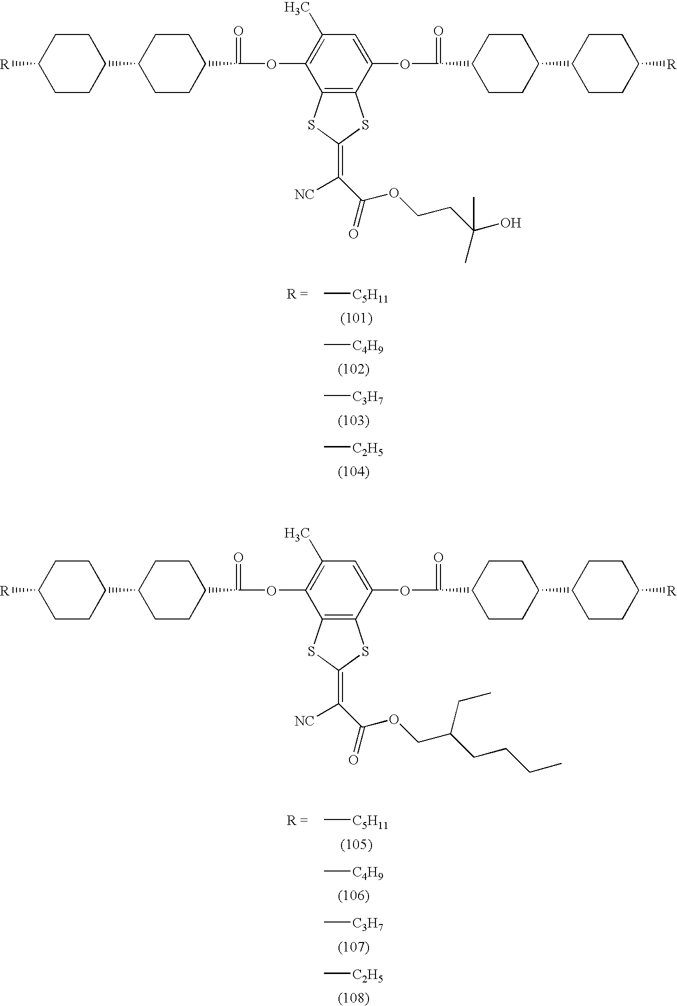

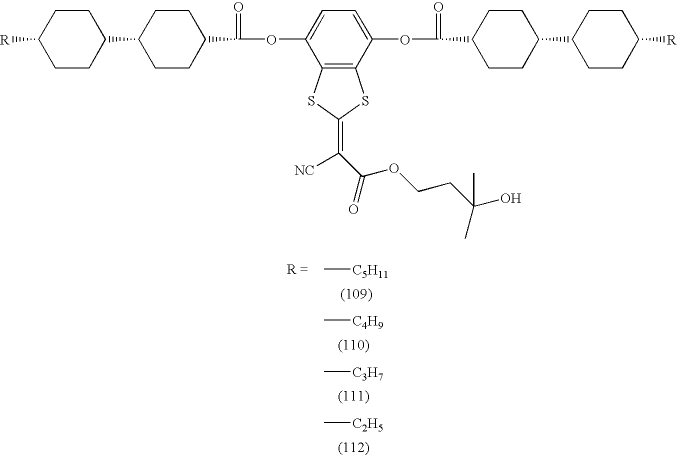

The compound represented by the formula (I) or (II) may be synthesized referring to known methods. For example, Example Compound (I) may be synthesized according to the following scheme.

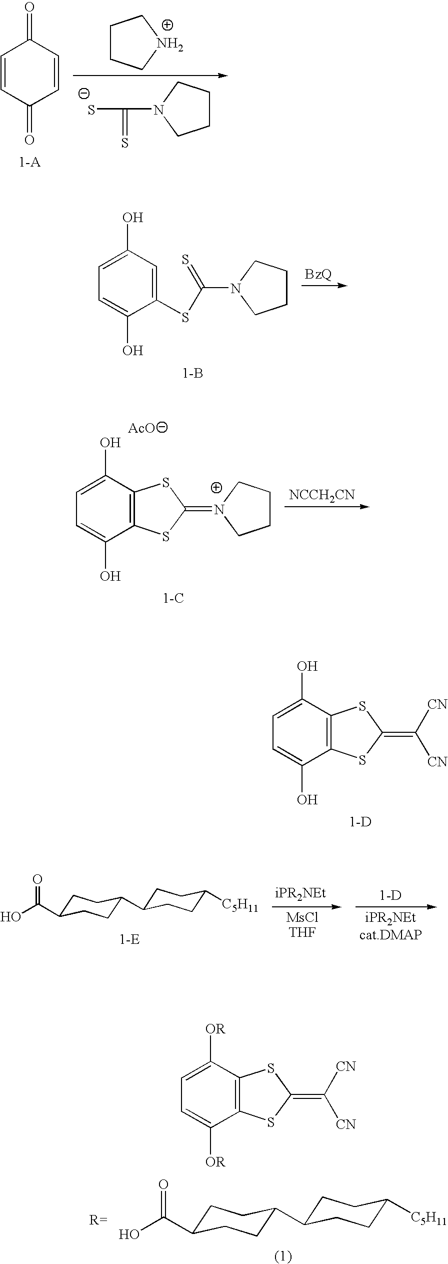

In the above scheme, the steps for producing Compound (1-d) from Compound (1-A) may be carried out referring to the description in “Journal of Chemical Crystallography” (1997); 27(9); p. 515-526.

As shown in the above scheme, Example Compound (I) may be produced as follows. A tetrahydrofuran solution of Compound (1-E) is added with methanesulfonic acid chloride, added dropewise with N,N-di-iso-propylethylamine and then stirred. After that, the reaction solution is added with N,N-di-iso-propylethylamine, added dropewise with a tetrahydrofuran of Compound (1-D), and then added dropewise with a tetrahydrofuran solution of N,N-dimethylamino pyridine (DMAP).

The rod-like aromatic compounds described in Japanese Laid-open Patent publication (occasionally referred to as “JPA”) No. 2004-50516, on pages 11-19, may be employed as the Re enhancer.

One species or two or more species of compounds may be used as the Re enhancer. Employing two or more species as the Re enhancer is preferable since it is possible to widening the adjustable retardation range and to facilitate adjustment of retardation within the preferred range.

The amount of the Re enhancer is preferably from 0.1 to 20 mass % and more preferably from 0.5 to 10 mass % with respect to 100 parts mass of cellulose acylate. When the cellulose acylate film is produced according to a solvent cast method, the Re enhancer may be added to the dope. The addition of the Re enhancer to the dope may be conducted any stage, and for example, a solution of the Re enhance may be prepared by dissolving it in an organic solvent such as alcohol, methylene chloride or dioxolane and then added to the dope; or the Re enhancer may be added to the dope directly.

### <<Rth Enhancer>>

For preparing a cellulose acylate film satisfying the condition required for the optical film, an Rth enhancer may be added to the cellulose acylate film. It is noted that the term “Rth enhancer” is used for any compounds capable of developing or enhancing birefringence in the thickness direction.

Preferably the compounds having an absorption peak at a wavelength from 250 nm to 380 nm and exhibiting high polarizability anisotropy are employed as the Rth enhancer. The compounds represented by the formula (I) are especially preferred as the Rth enhancer.

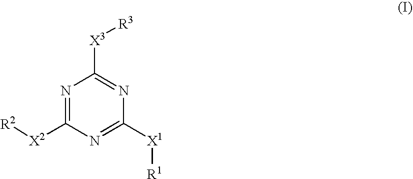

In the formula (I), X¹ represents a single bond, —NR⁴—, —O— or —S—; X represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, I-(1) to IV-(10), of the compound represented by the formula (I) include, but are not limited to, those shown below.

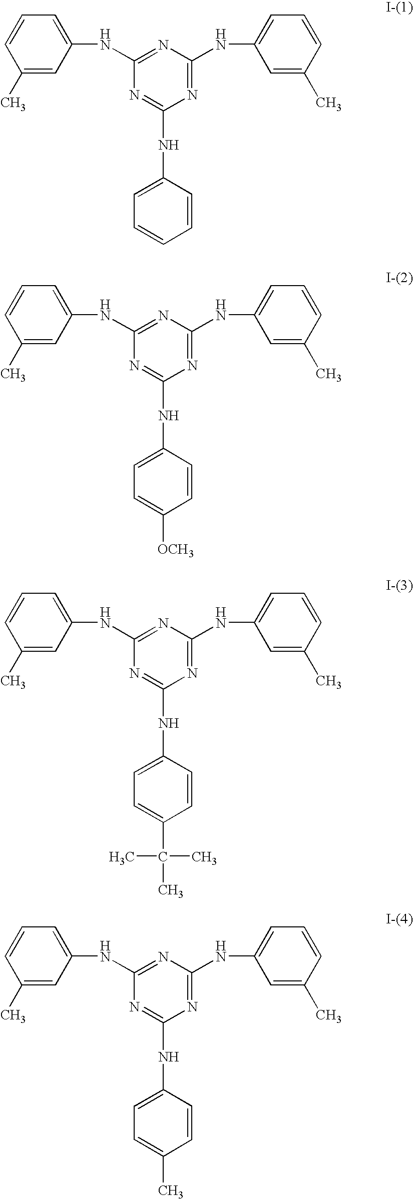

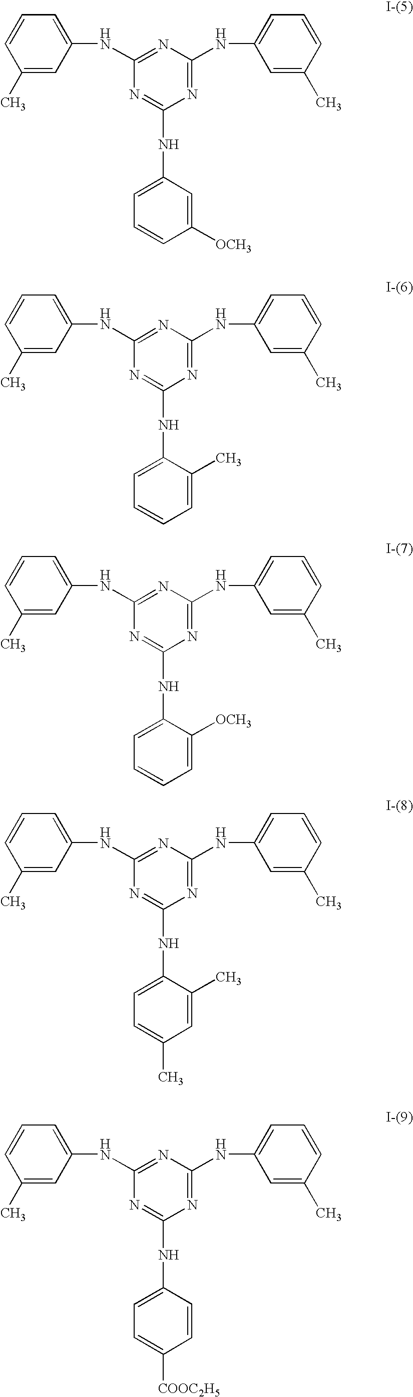

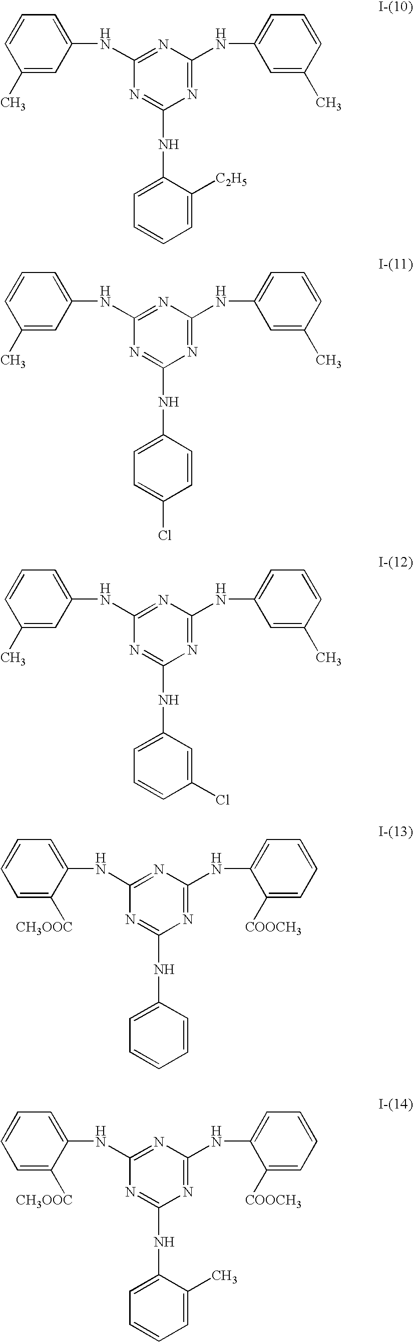

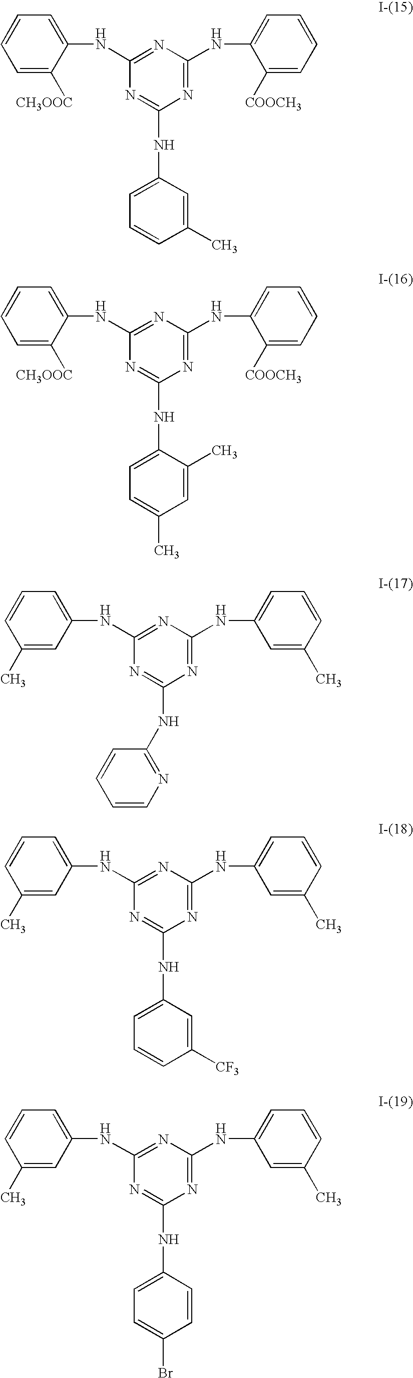

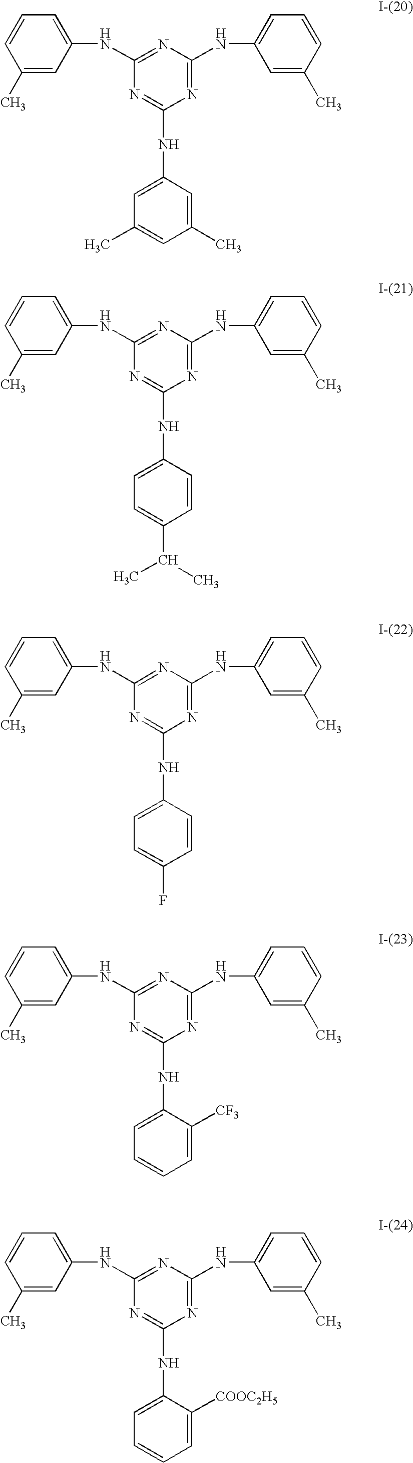

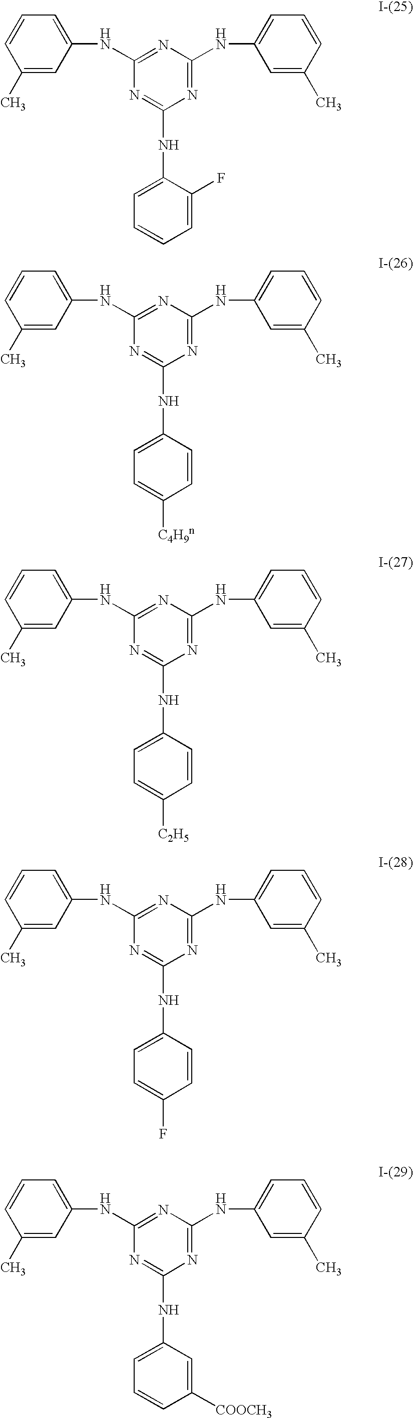

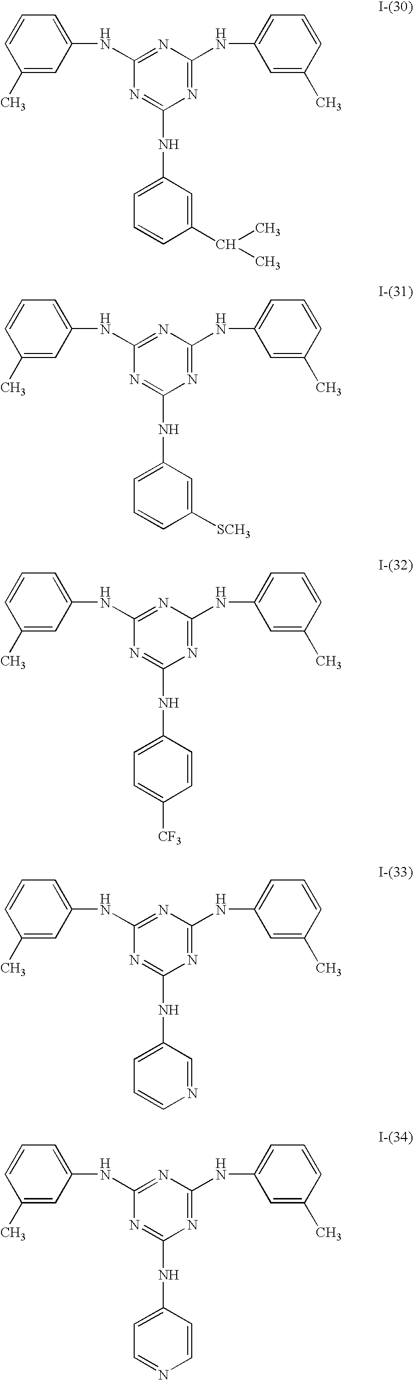

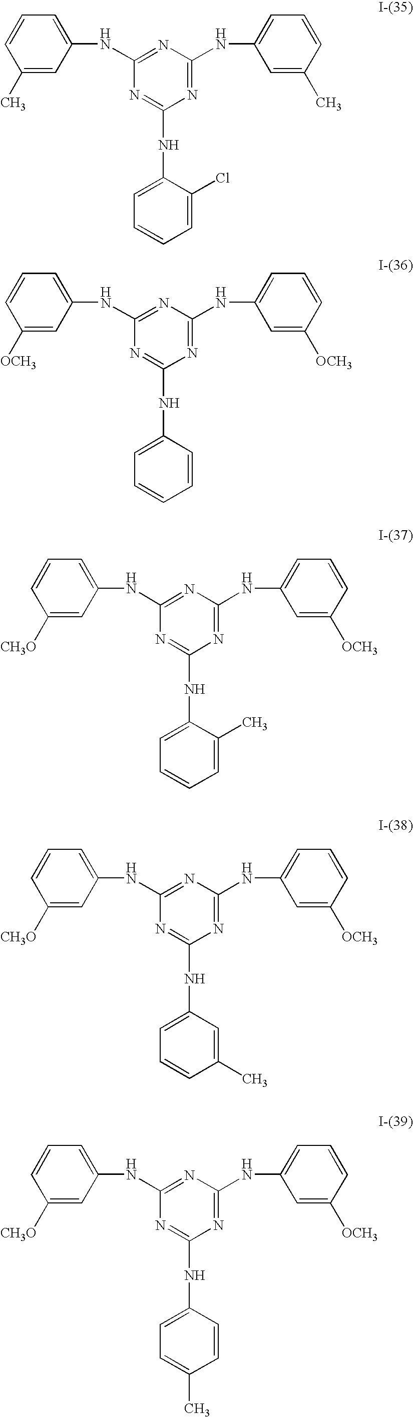

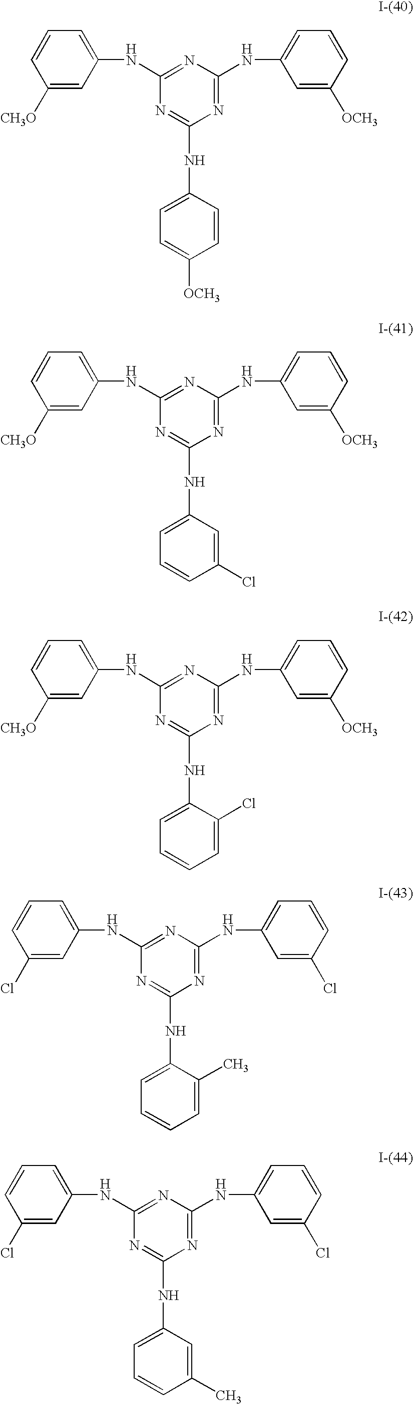

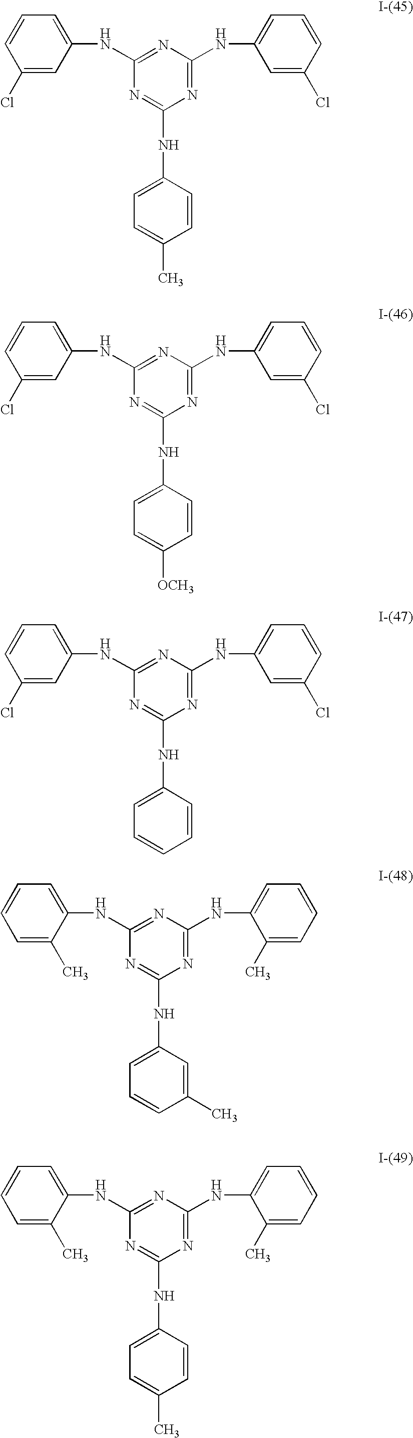

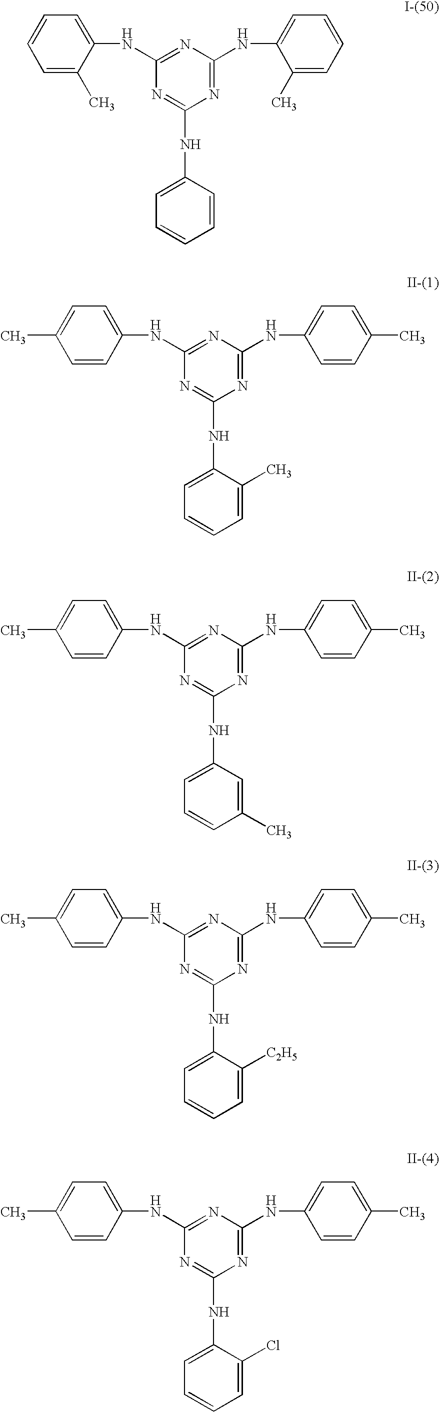

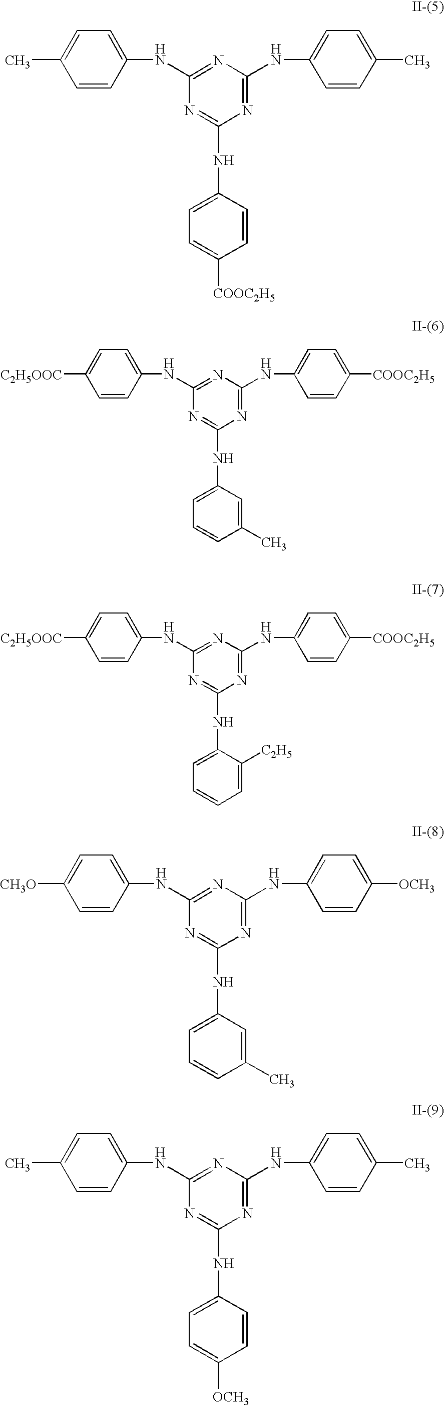

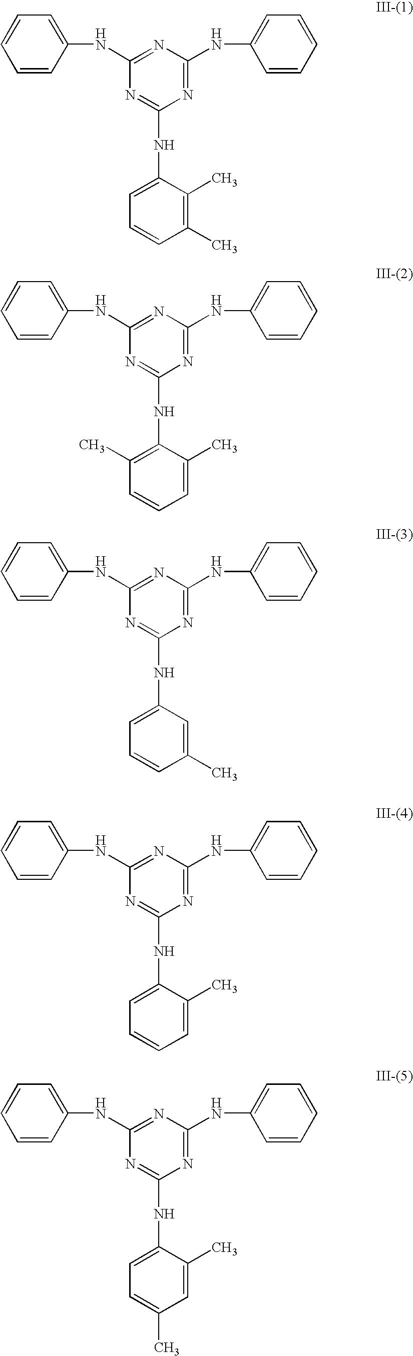

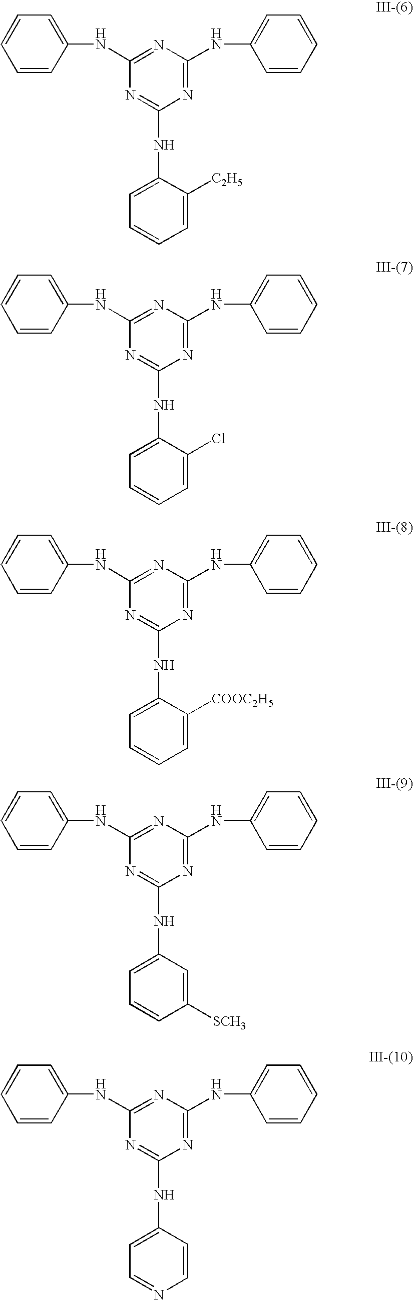

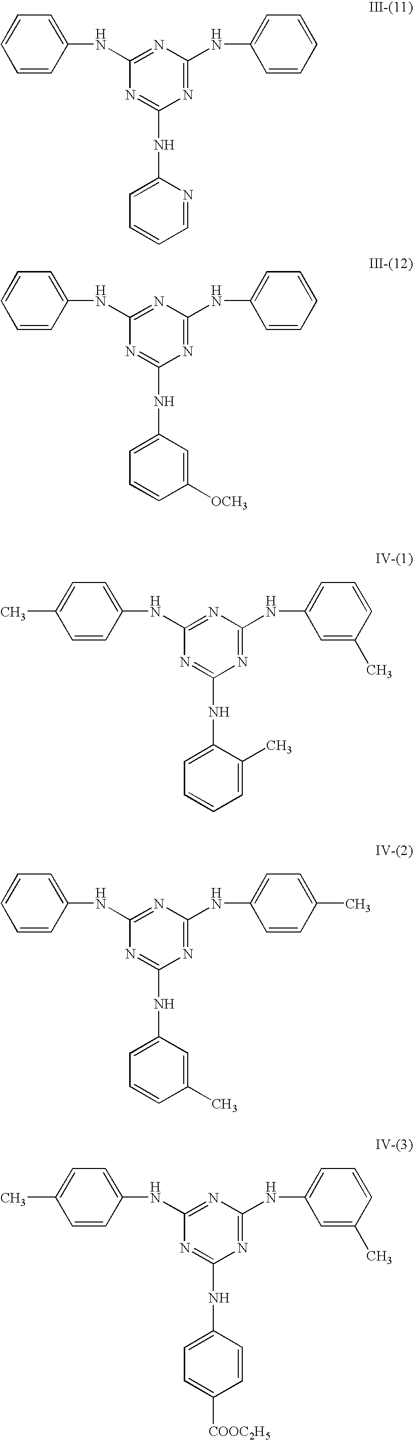

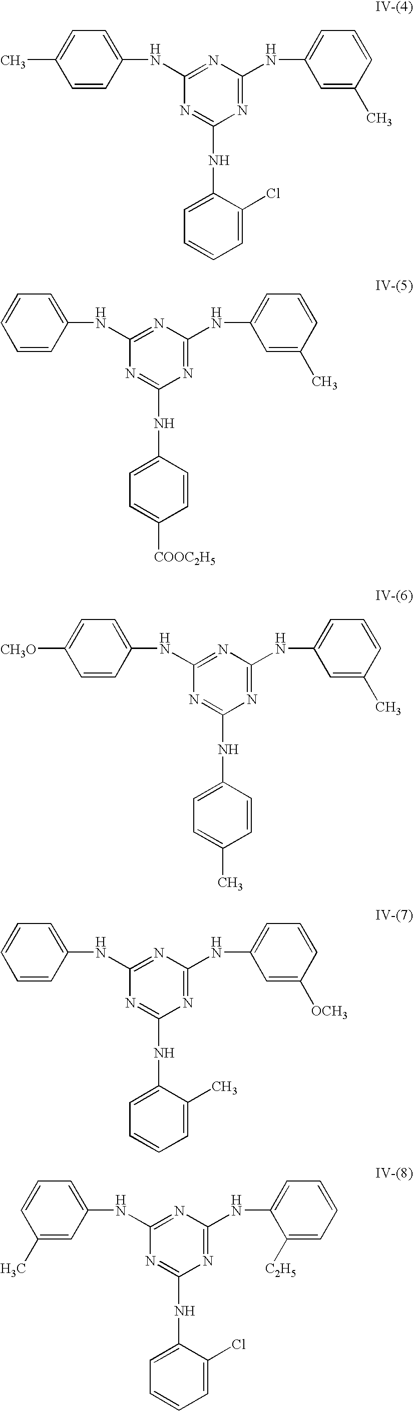

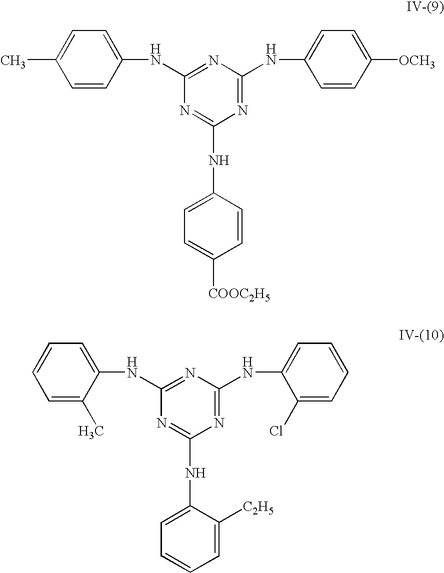

The compounds represented by the formula (III) are also preferred as the Rth enhancer. The formula (III) will be described in detail.

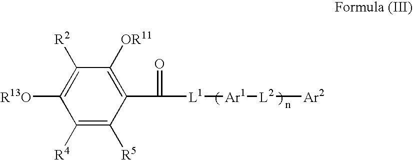

In the formula (III), R², R⁴ and R⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other. R¹¹ and R¹³ are different from each other, and the alkyl group represented by R¹³ doesn't include any hetero atoms.

In the formula (III), R², R⁴ and R⁵ respectively represent a hydrogen atom or a substituent. The substituent may be selected from Substituent Group T described later.

In the formula (III), R² preferably represents a hydrogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₋₈, the more preferred is C₁₋₆ and the specially preferred is C₁₋₄) alkoxy group; further much more preferably a hydrogen atom, a C₁₋₄ alkyl group or a C₁₋₄ alkoxy group; especially preferably a hydrogen atom, methyl or methoxy; and most preferably a hydrogen atom.

In the formula (III), R⁴ preferably represents a hydrogen atom or an electron donating substituent; more preferably a hydrogen atom, an alkyl group, an alkoxy group, an amino group or hydroxy; much more preferably a hydrogen atom, a C₁₋₄ alkyl group or a C₁₋₁₂ (the preferred is C₁₋₈, the more preferred is C₁₋₆ and the especially preferred is C₁₋₄) alkoxy group; and especially preferably a hydrogen atom, a C₁₋₄ alkyl group or a C₁₋₄ alkoxy group; and most preferably a hydrogen atom or methoxy.

In the formula (III), R⁵ preferably represents a hydrogen atom, a halogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₈, the more preferred is C₁₋₆ and the especially preferred is C₁₋₄) alkoxy group; especially preferably a hydrogen atom, methyl or methoxy; and most preferably a hydrogen atom.

In the formula (III), R¹¹ and R¹³ respectively represent a hydrogen atom or an alkyl group, provided that R¹¹ and R¹³ are different from each other and the alkyl group represented by R¹³ doesn't include any hetero atoms. The term “hetero atom” is used for any atoms other than hydrogen and carbon atoms and examples of the hetero atom include oxygen, nitrogen, sulfur, phosphorus, halogen (F, Cl, Br, I) and boron atoms.

The alkyl group represented R¹¹ or R¹³ may have a linear or branched chain structure or a cyclic structure, and be selected from not only non-substituted alkyl groups but also substituted alkyl groups. The alkyl group is preferably selected from substituted or non-substituted C₁₋₃₀ alkyl groups, substituted or non-substituted C₃₋₃₀ cycloalkyl groups, substituted or non-substituted C₅₋₃₀ bicycloalkyl groups, namely monovalent groups made of C₅₋₃₀ bicycloalkanes by removing a hydrogen atom therefrom, and tricycloalkyl groups.

Preferable examples of the alkyl group represented by R¹¹ or R¹³ include methyl, ethyl, n-propyl, isopropyl, n-butyl, sec-butyl, n-pentyl, iso-pentyl, n-hexyl, n-heptyl, n-octyl, tert-octyl, 2-ethylhexyl, n-nonyl, 1,1,3-trimethyl hexyl, n-decyl, 2-hexyldecyl, cyclohexyl, cycloheptyl, 2-hexenyl, oleyl, linoleyl, and linolenil. Examples of the cycloalkyl group include cyclohexyl, cyclopentyl, 4-n-dodecylcyclohexy; and examples of the bicycloalkyl group include bicyclo[1,2,2]heptane-2-yl and bicyclo[2,2,2]octane-3-yl.

R¹¹ preferably represents a hydrogen atom, methyl, ethyl, n-propyl or iso-propyl; and more preferably a hydrogen atom or methyl; and most preferably methyl.

R¹³ preferably represents a C₂ or longer alkyl group, and more preferably a C₃ or longer alkyl group. Among theses, branched or cyclic alkyl groups are preferred.

Specific examples (O-1 to O-20) of the alkyl group represented by R¹³ include, but are not limited to, those shown below. It is noted that “#” means the position of the oxygen atom side.

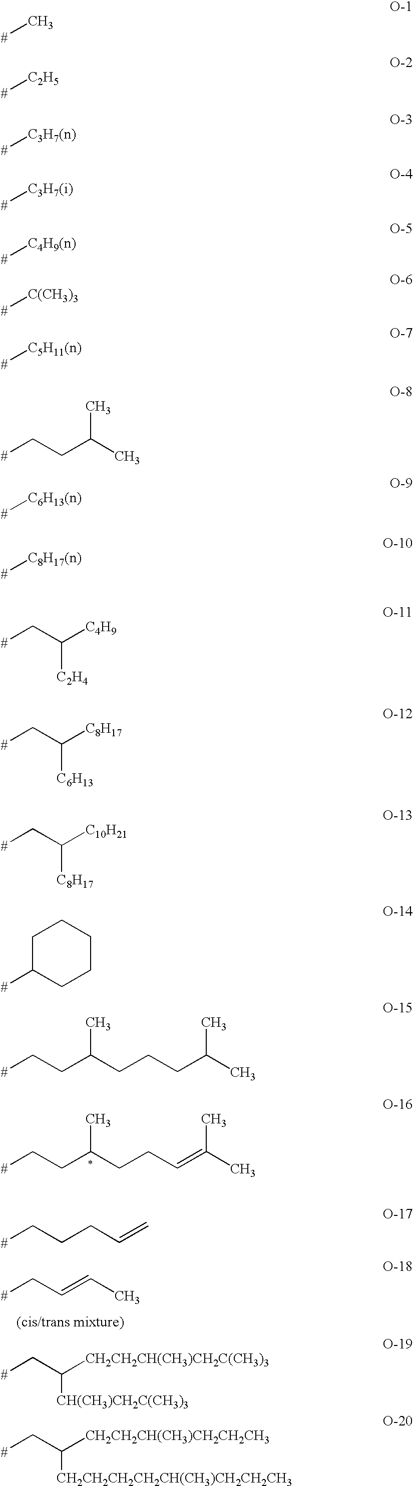

In the formula (III), Ar¹ represents an arylene group or an aromatic heterocyclic group and Ar¹ in each repeating unit may be same or different.

In the formula (III), Ar² represents an aryl group or an aromatic heterocyclic group.

The arylene group presented by Ar¹ in the formula (III) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar¹ is preferably selected from C₆₋₂₀, more preferably C₆₋₁₂ arylene groups, such as phenylene, p-methylphenylen and naphtylene.

The arylene group presented by Ar² in the formula (III) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar² is preferably selected from C₆₋₂₀, more preferably C₆₋₁₂ arylene groups, such as phenylene, p-methylphenylen and naphtylene.

The aromatic heterocyclic group represented by Ar¹ or Ar² in the formula (III) may be selected from the groups of aromatic rings in which at least one hetero atom selected from oxygen, nitrogen and sulfur atoms is embedded, and is preferably selected from the groups of 5- or 6-membered aromatic rings in which at least one of a nitrogen and sulfur atoms is embedded. The aromatic heterocyclic group may have at least one substituent. The substituent may be selected from Substituent Group T.

Examples of the aromatic heterocyclic group represented by Ar¹ or Ar² in the formula (III) include furan, pyrrole, thiophene, imidazole, pyrazole, pyridine, pyrazine, pyridazine, triazole, triazine, indole, indazole, purine, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenadine, tetrazole, benzimidazole, benzoxazole, benzthiazole, benztriazole, tetraza indeline, pyrrolotriazole and pyrazotriazole. Preferred examples of the aromatic heterocyclic group include benzimidazole, benzoxazole, benzthiazole and benztriazole.

In the formula (III), L¹ and L² independently represent a single bond or a bivalent linking group. L¹ and L² may be same or different from each other. And L² in each repeating unit may be same or different from each other.

The bivalent linking group is preferably selected from the group consisting of —O—, —NR— (R represents a hydrogen atom or a substituted or non-substituted alkyl or aryl group), —CO—, —SO₂—, —S—, an alkylene group, a substituted alkylene group, an alkenylene group, a substituted alkenylene group, an alkynylene group, a substituted alkynylene group and any combinations of tow or more selected therefrom; and more preferably from the group consisting of —O—, —NR—, —CO—, —SO₂NR—, —NRSO₂—, —CONR—, —NRCO—, —COO—, —OCO— and an alkynylene group. Preferably, R represents a hydrogen atom.

In the compound represented by the formula (III), Ar¹ binds to L¹ and L². For the compound having a phenylene as Ar¹, it is preferable that L¹-Ar¹-L² and L²-Ar¹-L² are in a para-position (1,4-position) relation.

In the formula (III), n is an integer equal to or more than 3, preferably from 3 to 7, more preferably from 3 to 6 and much more preferably from 3 to 5.

Preferable examples of the formula (III) include the compounds represented by the formula (IV) and formula (V) shown below.

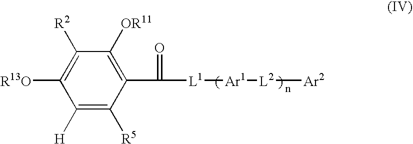

In the formula (IV), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (IV), the meanings of R², R⁵, R¹¹ and R¹³ are same as those in the formula (III); and preferred examples of R², R⁵, R¹¹ and R¹³ are same as those in the formula (III). In the formula (IV), the meanings of L¹, L², Ar¹ and Ar² are same as those in the formula (III); and preferred examples of L¹, L², Ar¹ and Ar² are same as those in the formula (III).

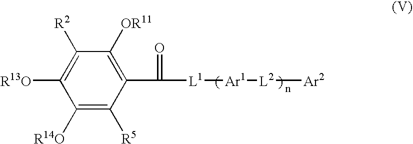

In the formula (V), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V), the meanings of R², R⁵, R¹¹ and R¹³ are same as those in the formula (III); and preferred examples of R², R⁵, R¹¹ and R¹³ are same as those in the formula (III). In the formula (V), the meanings of L¹, L², Ar¹ and Ar² are same as those in the formula (III); and preferred examples of L¹, L², Ar¹ and Ar² are same as those in the formula (III).

In the formula (V), R¹⁴ represents a hydrogen atom or an alkyl group; and examples of the alkyl group are same as those preferably exemplified as an alkyl group represented by R¹¹ or R¹³. In the formula, R¹⁴ preferably represents a hydrogen atom or a C₁₋₄ alkyl group, more preferably a hydrogen atom or a C₁₋₃ alkyl group, and much more preferably methyl. In the formula, R¹¹ and R¹⁴ may be same or different from each other, and it is most preferred that both of R¹¹ and R¹⁴ are methyl.

Preferable examples of the compound represented by the formula (V) include the compounds represented by the formula (V-A) and (V-B).

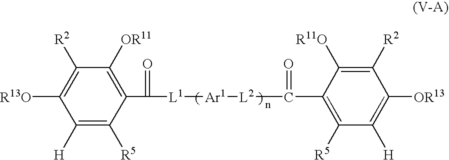

In the formula (V-A), R² and R⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-A), the meanings and preferable examples of R², R⁵, R¹¹, R¹³, L¹, L², Ar¹ and n may be same as those in the formula (III).

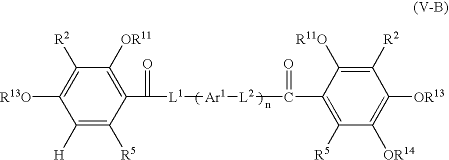

In the formula (V-B), R² and R⁵ independently represent a hydrogen atom or a substituent; R¹¹, R¹³ and R¹⁴ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-B), the meanings and preferable examples of R², R⁵, R¹¹, R¹³, R¹⁴, L¹, L², Ar¹ and n may be same as those in the formula (III).

“Substituent Group T” will be described below.

### Substituent Group T:

Halogen atoms such as fluorine, chlorine, bromine and iodine atoms; alkyls (preferablyC₁₋₃₀alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo[1,2,2]heptane-2-yl and bicyclo[2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N—(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Same or different two or more substituents may be selected. If possible, the substituents may bond to each other to form a ring.

Preferable examples of the compound represented by the formula (V-A) include the compounds in which R¹¹ is methyl, both of R² and R⁵ are hydrogen atoms, R¹³ is a C₃ or longer alkyl group, L¹ is a single bond, —O—, —CO—, —NR—, —SO₂NR—, —NRSO₂—, —CONR—, —NRCO— (R is a hydrogen atom or a substituted or non-substituted alkyl or aryl group, and preferably a hydrogen atom), —COO—, —OCO— or an alkylene; L² is —O— or —NR— (R is a hydrogen atom or a substituted or non-substituted alkyl or aryl group, and preferably a hydrogen atom); Ar¹ is an arylene group, and n is an integer from 3 to 6.

Examples of the compound represented by the formulae (V-A) and (V-B) include, but are not limited to, those shown below.

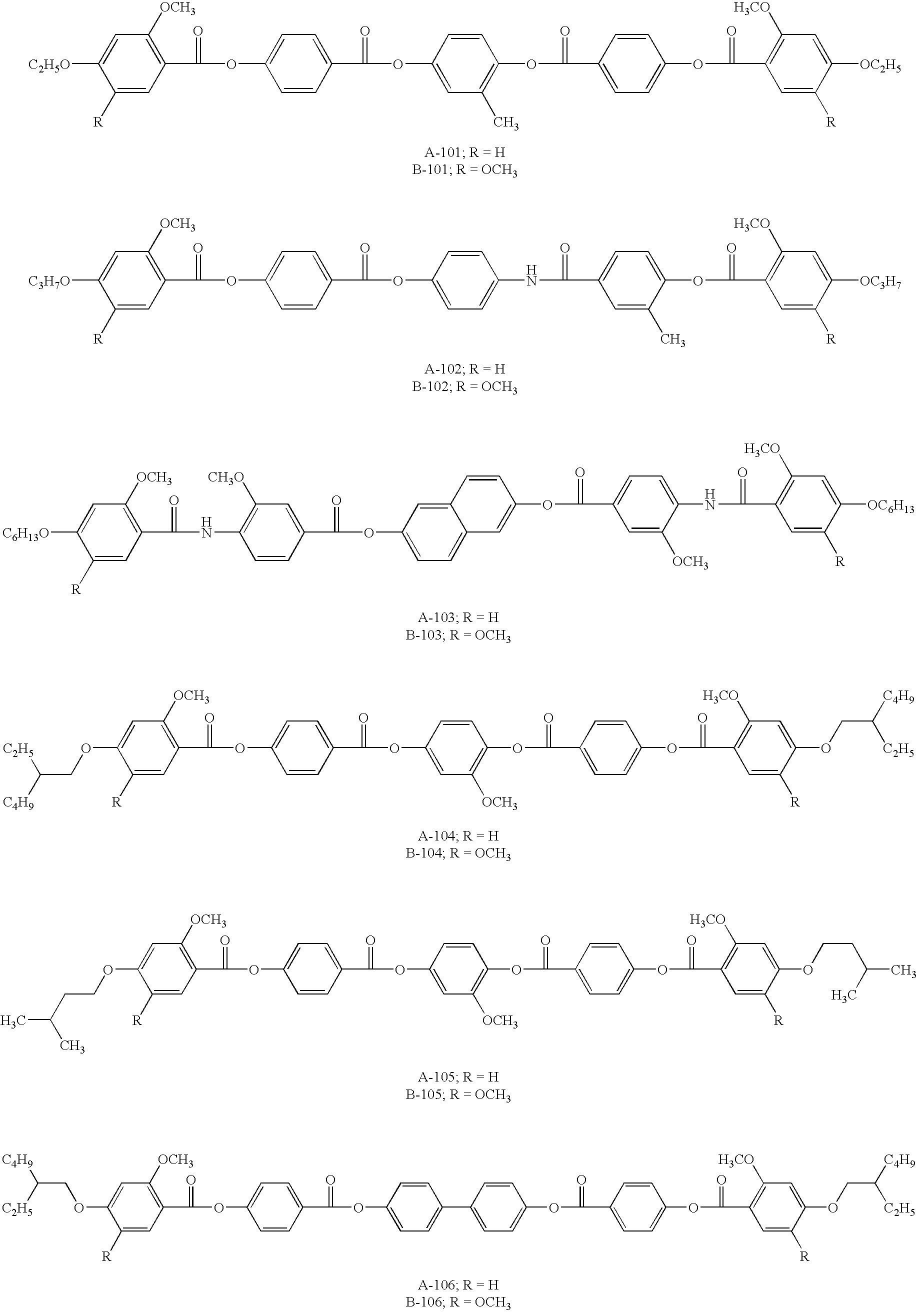

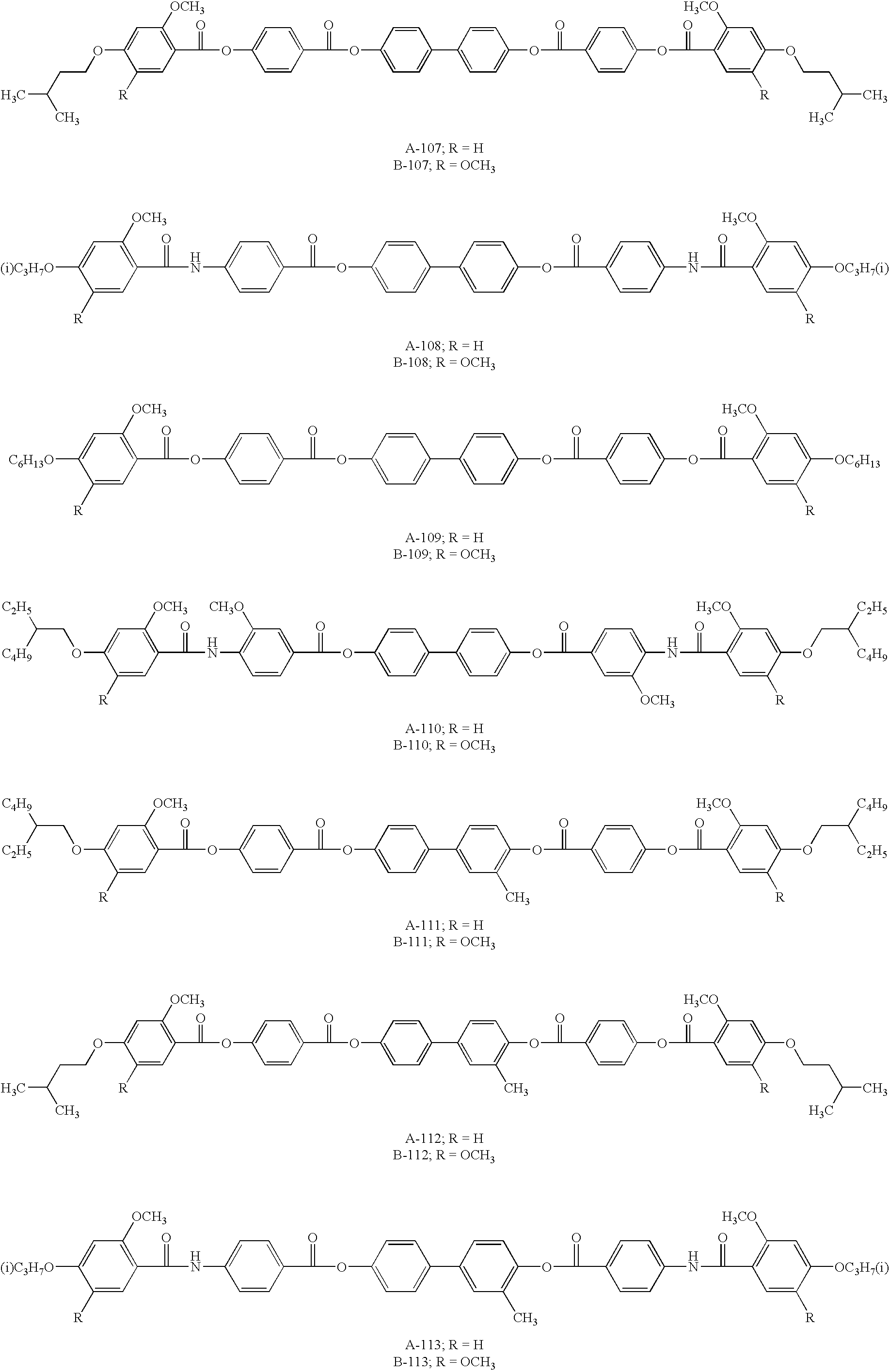

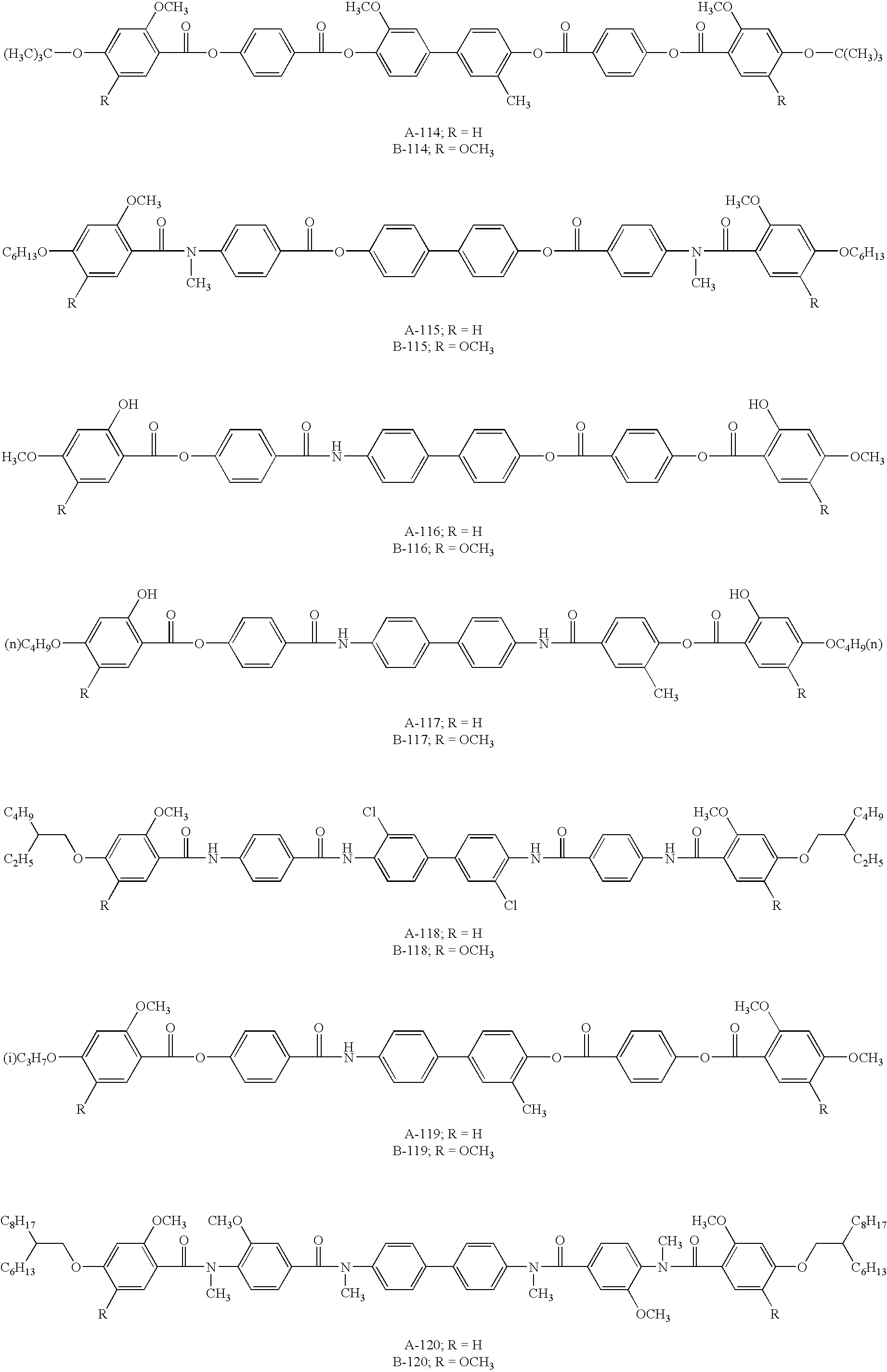

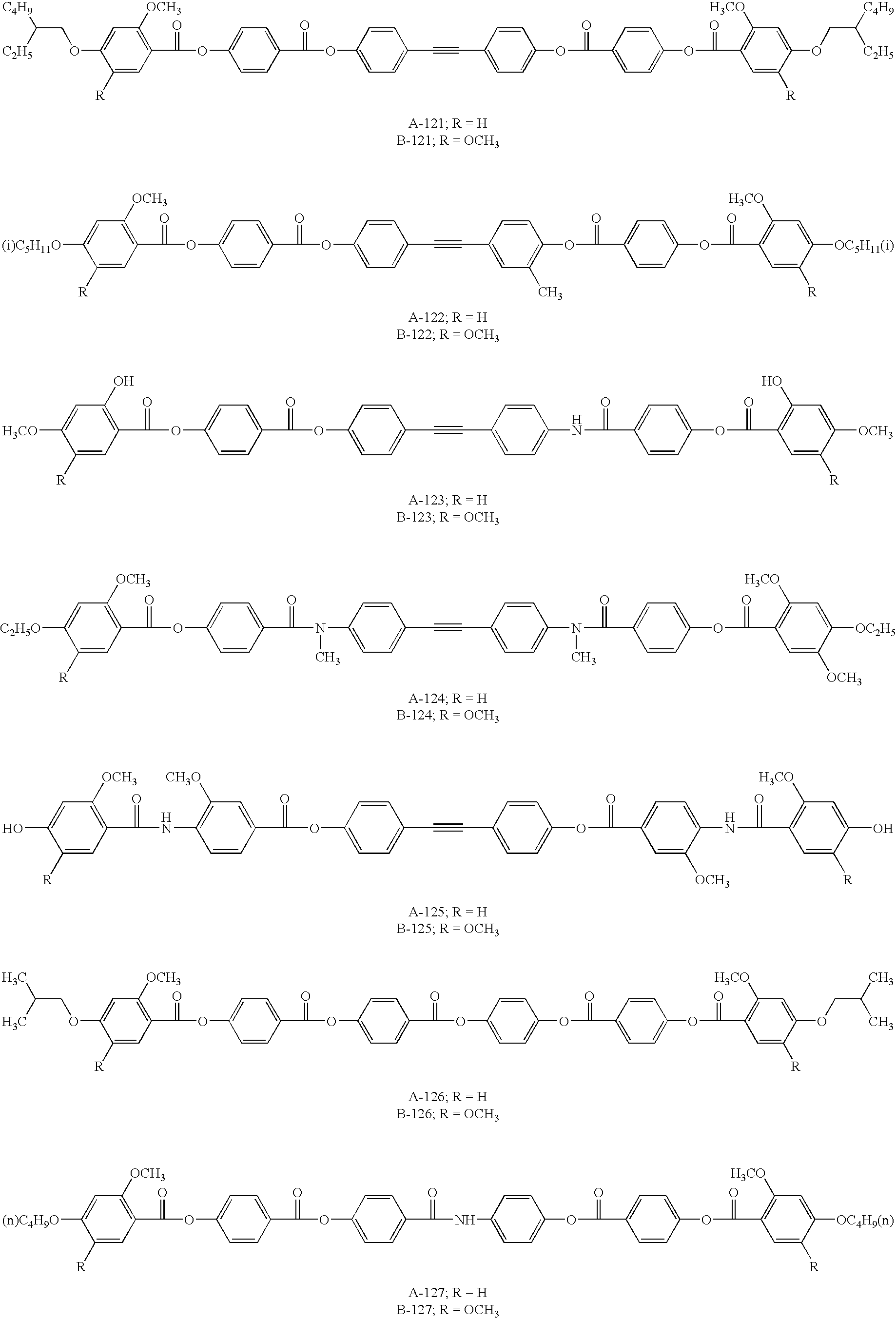

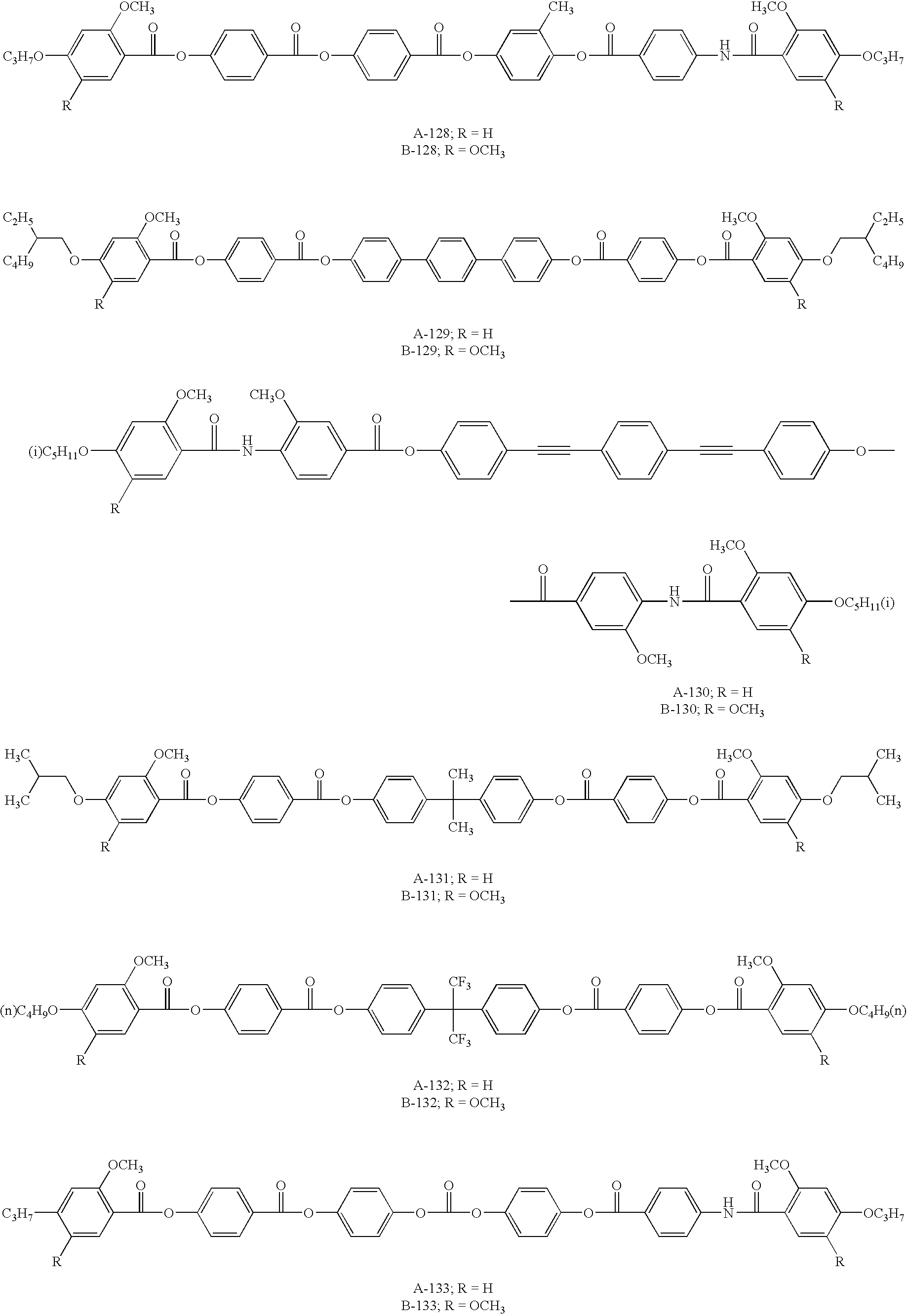

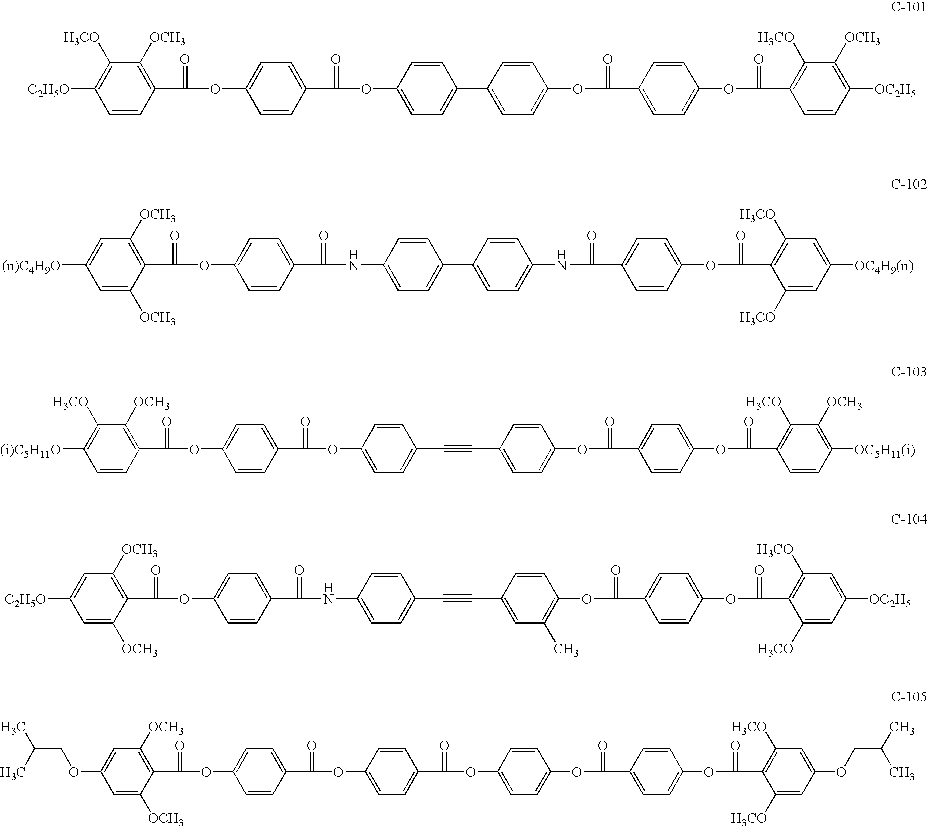

The compound represented by the formula (III) may be produced by a general esterification or a general amidation of a substituted benzoic acid, which may be synthesized previously, and a phenol derivative or a aniline derivative. The esterification or amidation may be carried out according to any method which can make an ester or amide bonding. For example, the compound may be produced as follows:

a substituted benzoic acid is converted into an acid halide, and, then, a condensation reaction of the acid halide and a phenol derivative or an aniline derivative is carried out; or

a dehydration condensation of a substituted benzoic acid and a phenol derivative or an aniline derivative is carried out in the presence of a condensation agent or catalyst.

The former method is preferred in terms of the production process.

Reaction solvent, which can be employed in the process of producing the compound represented by the formula (III), is preferably selected from the group consisting of hydrocarbon base solvents such as toluene and xylene; ether base solvents such as dimethylether, tetrahydrofuran and dioxane; ketone base solvents; ester base solvents; acetonitrile, dimethyl formamide and dimethylacetamide. One solvent or tow or more solvents may be employed. Among these, toluene, acetonitrile, dimethylformamide and dimethylacetamide are preferred.

The reaction temperature is preferably set within the range from 0 to 150° C., more preferably from 0 to 100° C., much more preferably from 0 to 90° C., and especially preferably from 20 to 90° C.

The reaction may be carried out with base or without base, the latter is preferred. Examples of the base include organic bases and inorganic bases, and organic bases such as pyridine and tertiary alkyl amine (e.g. triethyl amine and ethyl diisopropyl amine) are preferred.

The compound represented by the formula (V-A) or (V-B) can be produced according to any usual method. The compounds in which “n” is 4 may be produced as follows:

a reaction of a starting material having a following structure “A” with a derivative having a reactive site such as hydroxyl and amino is carried out to generate an intermediate B-2 shown below; a reaction of the intermediate B-2 with a compound “C” shown below to connect two molecules of the intermediate B-2 with a molecule of the compound “C” shown below; and then a compound represented by the formula (V-A) or (V-B) can be obtained.

The method to be employed for producing the compound is not limited to the above mentioned method.

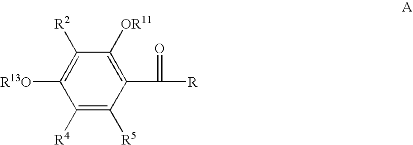

In the structure “A”, R represents a reactive group such as hydroxyl and a halogen atom; R¹¹, R², R¹³ and R⁵ are same as described above; and R⁴ represents a hydrogen atom or the above mentioned OR¹⁴.

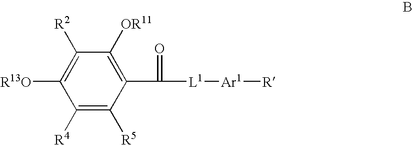

In the formula, R′ represents a reactive group such as carboxyl; R¹¹, R², R¹³, R⁴, R⁵, Ar¹ and L¹ are same as described above.

R—Ar²-L²-Ar²—R′ C

In the formula, R and R′ represent a reactive group such as hydroxyl and amino; and Ar² and L² are defined as Ar¹ and L¹ are defined above.

The amount of the Rth enhancer is preferably from 0.1 to 30 mass %, more preferably from 1 to 25 mass % and much more preferably from 3 to 15 mass % with respect to the total mass of cellulose acylate.

When the cellulose acylate film is produced according to a solvent cast method, the Rth enhancer may be added to the dope. The addition of the Rth enhancer to the dope may be conducted any stage, and for example, a solution of the Rth enhancer may be prepared by dissolving it in an organic solvent such as alcohol, methylene chloride or dioxolane and then added to the dope; or the Rth enhancer may be added to the dope directly.

One or more types of compounds selected from the formulae (I), (III)-(V) may be used as the Rth enhancer.

For producing a cellulose acylate film to be used as the optical film, at least one UV absorbent may be employed in combination with or in place of the Rth enhancer. The UV absorbent can also function as an Rth enhancer. Examples of the UV absorbent include oxybenzophenone compounds, benzotriazole compounds, salicylate compounds, benzophenone compounds, cyanoacrylate compounds, and nickel complex compounds; and preferred are benzotriazole compounds causing little coloration. In addition, UV absorbents described in Japanese Laid-Open Patent Publication Nos. 10-182621 and 8-337574, and UV absorbent polymers described in Japanese Laid-Open Patent Publication No. 6-148430 are also preferably used herein. For the UV absorbent for the cellulose acylate film, preferred are those having an excellent ability to absorb UV rays having a wavelength of at most 370 nm, in terms of preventing degradation of polarizing elements and liquid crystals, and those not almost absorbing visible light having a wavelength of at least 400 nm in terms of the image display capability.

Examples of the benzotriazole-type UV absorbent usable in the invention are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthal imidomethyl)-5′-methylphenyl)benzotriazole, 2,2-methylenebis(4-(1,1,3,3-tetramethylbutyl)-6-(2H-benzotriazol-2-yl)phenol, 2-(2′-hydroxy-3′-tert-butyl-5′-methylphenyl)-5-chlorobenzotriazole, 2-(2H-benzotriazol-2-yl)-6-(linear or branched dodecyl)-4-methylphenol, a mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl) phenyl]propionate, to which, however, the invention should not be limited. In addition, commercial products of TINUVIN 109, TINUVIN 171, TINUVIN 326 (all by Ciba Speciality Chemicals) are also preferably usable herein.

### <<Agent for Controlling Wavelength Dispersion of Retardation>>

For producing a cellulose acylate film satisfying properties required for the optical film, at least one UV absorbent may be employed. The UV absorbent can also function as an agent for controlling wavelength dispersion of retardation. Examples of the UV absorbent include oxybenzophenone compounds, benzotriazole compounds, salicylate compounds, benzophenone compounds, cyanoacrylate compounds, and nickel complex compounds; and preferred are benzotriazole compounds causing little coloration. In addition, UV absorbents described in Japanese Laid-Open Patent Publication Nos. 10-182621 and 8-337574, and UV absorbent polymers described in Japanese Laid-Open Patent Publication No. 6-148430 are also preferably used herein. For the UV absorbent for the cellulose acylate film, preferred are those having an excellent ability to absorb UV rays having a wavelength of at most 370 nm, in terms of preventing degradation of polarizing elements and liquid crystals, and those not almost absorbing visible light having a wavelength of at least 400 nm in terms of the image display capability. <<Plasticizer>>

A plasticizer such as triphenyl phosphate or biphenyl phosphate may be added to the polymer film (preferably cellulose acylate film) to be used as the optical film.

The thickness of the optical film for use in the invention is preferably from 30 to 200 μm, more preferably from 35 to 100 μm.

### (Production of Polarizing Plate)

The above-mentioned optical film and the above-mentioned polarizing film are stuck together to fabricate a polarizing plate. In general, the polarizing film has a protective film on both its surfaces. The optical film may serve as the protective film for the polarizing film. When the polarizing plate is incorporated into a liquid-crystal display device, the protective film on the surface side thereof shall be disposed on an outer side, and therefore it is desirable that a low moisture-penetration material is used for the film in terms of durability thereof. Concretely, preferred is a film having a degree of moisture-permeation equal to or less than 300 g/(m²·day), more preferably equal to or less than 200 g/(m²·day), even more preferably equal to or less than 50 g/(m²·day), still more preferably equal to or less than 20 g/(m²·day). Not specifically defined, the lowermost limit of the degree of moisture-permeation of the film may be generally 10 g/(m²·day) or so. The degree of moisture-permeation of the film is measured at 40° C. and 60% RH. Its details are described in JIS-0208. For the protective film having the characteristics, preferred is a norbornene polymer film, and a commercial product, ZEONOR film may be used. Also preferred for use herein is a low moisture-permeation material prepared by forming a low moisture-permeation coating layer on a film substrate. One example of the coating layer is a polymer that contains a repetitive unit derived from a chlorine-containing vinyl monomer (hereinafter this may be referred to as a chlorine-containing polymer). The chlorine-containing vinyl monomer generally includes vinyl chloride, vinylidene chloride. The chlorine-containing polymer may be obtained through copolymerization of such a vinyl chloride or vinylidene chloride monomer with a monomer copolymerizable with it. The chlorine-containing vinyl monomer may be copolymerized with any other monomer. The monomer copolymerizable with the chlorine-containing vinyl monomer may be selected from olefins, styrenes, acrylates, methacrylates, acrylamides, methacrylamides, itaconic diesters, maleates, fumaric diesters, N-alkylmaleimides, maleic anhydride, acrylonitrile, vinyl ethers, vinyl esters, vinyl ketones, vinyl heterocyclic compounds, glycidyl esters, unsaturated nitriles, unsaturated carboxylic acids.

Because of the reason that a film having a low degree of moisture-permeation is disposed on the outer side of a liquid-crystal display device so as to prevent moisture penetration into the device and/or because of the reason that a film having a low degree of moisture-permeation is poorly adhesive to a polarizing element, a protective film for the polarizing film may be additionally disposed between the polarizing film and the low moisture-permeation film. For the protective film, preferred is a cellulose acylate film.

Between the polarizing film and the optical film, an additional protective film may also be disposed, having a function of protecting the polarizing film; however, in this case, it is desirable that a film having a retardation of nearly 0, for example, the cellulose acylate film described in JPA No. 2005-138375 is used for the protective film of the type in order that the additional protective film would not lower the optical compensatory potency of the structure.

In continuous production, the polarizing plate may be produced according to a roll-to-roll process. Briefly, the optical film and the polarizing film are prepared both as long films, they are rolled up, and they are stuck together, while unrolled, and then the thus-stuck laminate is again rolled up. For sticking them, an adhesive may be used.

In general, in a large-panel display device, the contrast reduction and the color shift in oblique directions are remarkable, and therefore the polarizing plate of the invention is especially suitable for use in large-panel liquid-crystal display devices. For the embodiment in which the polarizing plate is used in a large-panel liquid-crystal display device, for example, it is preferably shaped to have a film width equal to or larger than 1420 mm or 1470 mm. The polarizing plate of the invention may be produced not only as cut sheets capable of being directly incorporated into liquid-crystal display devices, but also as a long film in continuous production and wound up into a roll, and the rolled long film may be cut into sheets. The film roll of the latter case is stored and transported as it is, and when it is actually built in a liquid-crystal display device, then it is cut into a desired size. In one embodiment of a roll of the polarizing plate of the invention, the polarizing plate may have a length equal to or longer than 2000 m or 3900 m, and the long polarizing plate may be rolled up.

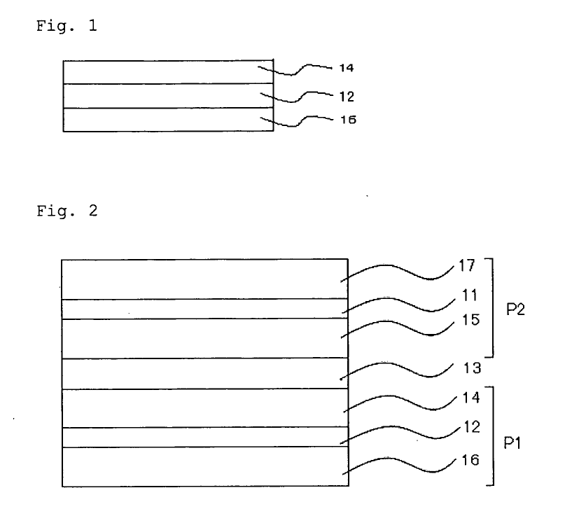

FIG. 1 is a schematic cross-sectional view of one example of the polarizing plate of the invention.

The polarizing plate of FIG. 1 comprises a polarizing film 12 of a polyvinyl alcohol film dyed with iodine or dichroic dye, an optical film 14 satisfying the above-mentioned predetermined requirements and disposed as a protective film on one surface of the film 12, and a protective film 16 disposed on the other surface of the film 12. When the polarizing plate is built in a liquid-crystal display device, the optical film 14 is to be the protective film on the side of the liquid-crystal cell in the device.

### [Liquid-Crystal Display Device]

The invention also relates to a liquid-crystal display device comprising the polarizing plate of the invention. One embodiment of the liquid-crystal display device of the invention comprises the polarizing plate of the invention, a liquid-crystal cell, and an optically-anisotropic layer satisfying the following relations (b1) and (b2):

|Rth(548)/Re(548)|>10 (b1)

Rth(628)−Rth(446)<0. (b2)

The driving mode of the liquid-crystal display device is not specifically defined, for which, for example, preferred is a horizontal alignment mode such as IPS mode and a vertically aligned mode in which the liquid-crystal cell does not include twisted alignment, more preferred is a vertically aligned mode.

FIG. 2 is a schematic cross-sectional view of the liquid-crystal display device of the above-mentioned embodiment.

FIG. 2 is a constitutional example of a VA-mode liquid-crystal display device, which comprises a VA-mode liquid-crystal cell 13, and a pair of polarizing plates P1 and P2 so disposed as to sandwich the liquid-crystal cell 13 therebetween. The polarizing plate P1 comprises a polarizing film 12 and protective films 14 and 16 disposed on both its surfaces. The protective film 14 disposed on the side of the liquid-crystal cell is an optical film satisfying the above relations (a1) to (a6), and functions as a first optically-anisotropic layer. The polarizing plate P2 comprises a polarizing film 11 and protective films 15 and 17 disposed on both its surfaces. The protective film 15 disposed on the side of the liquid-crystal cell is an optical film satisfying the above relations (b1) and (b2), and functions as a second optically-anisotropic layer. The polarizing plate P1 is a polarizing plate of the invention, having a transmittance through a pair of crossed polarizing plates equal to or less than 0.3% at 700 nm and a transmittance through a pair of crossed polarizing plates equal to or less than 0.1% at 410 nm.

The polarizing films 11 and 12 are, in general, so disposed that their transmission axes are perpendicular to each other. The first optically-anisotropic layer 14 has an in-plane slow axis, and this is preferably so disposed that its slow axis is perpendicular to the absorption axis of the first polarizing film 12.

The VA-mode liquid-crystal display device of the embodiment shown in FIG. 2 comprises the polarizing plate P1 of the invention, and provides an ideal neutral black in the normal direction in the black state; and in addition, the device comprises the first optically-anisotropic layer 14 satisfying the above formulae (a1) to (a6) and the second optically-anisotropic layer 15 satisfying the above relations (b1) and (b2), and therefore, even in oblique directions, the device may provide the ideal black without any color shift, any coloration or any degradation in contrast.

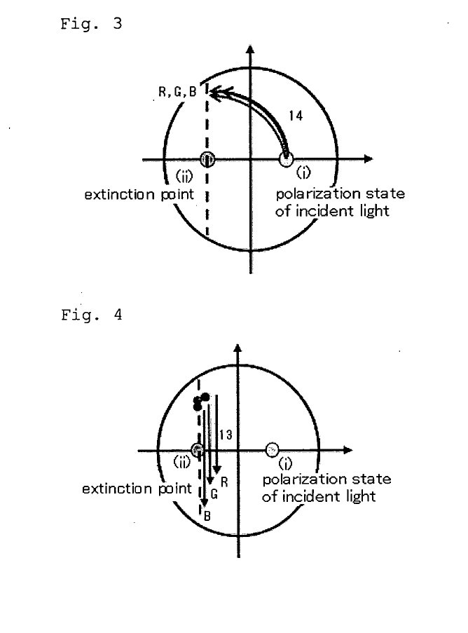

One example of optical compensation in the liquid-crystal display device of the invention is described on a Poincare sphere. FIG. 3 to FIG. 5 are views showing the change in the polarization state of incident light to the liquid-crystal display device of FIG. 2, on a Poincare sphere. The Poincare sphere is a three-dimensional map to describe a polarization state, and the equator of the sphere indicates linear polarization. In this, the light propagation direction in the liquid-crystal display device is at an azimuth direction of 45 degrees and a polar direction of 34 degrees. In FIG. 3 to FIG. 5, the S2 axis is an axis going through the paper vertically from the back to the top; and FIG. 3 to FIG. 5 show a view to see a Poincare sphere from the positive direction of the S2 axis. In this, S1, S2 and S3 coordinates indicate values of stoke parameters in a certain polarization state. FIG. 3 to FIG. 5 show the two-dimensional condition, in which, therefore, the displacement at the point before and after the change of the polarization state is shown by the linear arrows in the drawings. In fact, however, the polarization state change in light having passed through a liquid-crystal layer and an optically-compensatory film is represented by rotation at a specific angle around a specific axis determined in accordance with the individual optical characteristics, on a Poincare sphere. The rotation angle is proportional to the reciprocal number of the wavelength of the incident light, and is proportional to the magnitude of retardation in the retardation region through which the incident light runs.

The polarization state of the incident light having passed through the polarizing film 12 of the liquid-crystal display device of FIG. 2 corresponds to the point (i) in FIG. 3 to FIG. 5; and the polarization state of the light as blocked by the absorption axis of the polarizing film 11 in FIG. 2 corresponds to the point (ii) in FIG. 3. Heretofore, in a VA-mode liquid-crystal display device, the off-axis light leakage in an oblique direction is caused by the shift of the polarization state of the out-going light at the point (ii). The first optically-anisotropic layer 14 and the second optically-anisotropic layer 15 are used for changing the polarization state of the incident light correctly from the point (i) to the point (ii), including the polarization state change in the liquid-crystal cell 13.

First, the light having passed through the first optically-anisotropic layer 14 is converted by the retardation of the first optically-anisotropic layer 14. In this case, the conversion degree, or that is, the rotation angle on a Poincare sphere decreases with a longer wavelength; but on the other hand, the retardation of the first optically-anisotropic layer 14 has reversed wavelength dispersion characteristics of Re (Re decreases with a shorter wavelength), and therefore the two factors are offset each other, and as in FIG. 3, the polarization state of R light, G light and B light, after having passed through the first optically-anisotropic layer 14, could almost correspond on the S1 coordinates on a Poincare sphere.

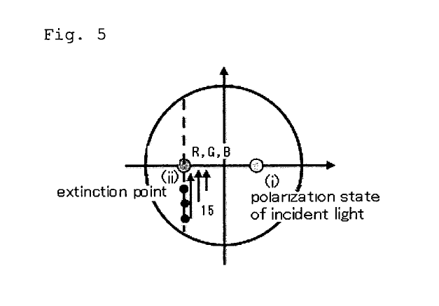

Afterwards, as in FIG. 4, the polarization state of the R light, the G light and the B light having passed through the VA-mode liquid-crystal cell 13 changes like the arrow 13 shown in the drawing, with the result that the S3 coordinates differ for light separation; and the separation may be evaded by utilizing the wavelength dispersion characteristics of retardation of the second optically-anisotropic layer 15. More concretely, when the second optically-anisotropic layer 15 is formed of a material that satisfies the above formula (b2) and has regular wavelength dispersion characteristics of Rth (Rth increases with a shorter wavelength within a visible wavelength range), then, as in FIG. 5, the polarization state of all the R light, the G light and the B light may be converted into that on the S1 axis, or that is, into the extinction point (ii) with no difference in the S1 coordinates for the light, as indicated by the arrow 15 in the drawing. As a result, in the oblique direction, the color shift may be reduced more and the contrast may be improved more.

Some examples of optical compensatory mechanisms are shown in FIG. 3 to FIG. 5, to which, however, the invention should not be limited.

The liquid-crystal display device of the invention is not limited to the constitution shown in FIG. 2. In FIG. 2, the liquid-crystal cell is sandwiched between the second optically-anisotropic layer and the first optically-anisotropic layer; however, not limited to the illustrated constitution, the second optically-anisotropic layer may be laminated on the first optically-anisotropic layer in another embodiment of the device of the invention.

### (Second Optically-Anisotropic Layer)

In this embodiment, preferably, the second optically-anisotropic layer has at least a thickness-direction retardation Rth and concretely satisfies the following relation (b1). Also preferably, the second optically-anisotropic layer has regular wavelength dispersion characteristics of Rth, or that is, its Rth increases with a shorter wavelength within a visible wavelength range, in terms of reducing the color shift in oblique directions; and more preferably, the layer satisfies the following relation (b2).

|Rth(548)/Re(548)|>10 (b1)

Rth(628)−Rth(446)<0. (b2)

The invention encompasses an embodiment in which Re of the second optically-anisotropic layer satisfies Re(548)=0. More preferably the layer satisfies Rth(548)/Re(548)>15. Even more preferably, Rth(548) is from 50 to 400 nm, still more preferably from 75 to 300 nm.

Needless-to-say, however, an embodiment where Rth of the second optically-anisotropic layer decreases with a shorter wavelength within a visible wavelength range, or that is, the layer has reversed wavelength dispersion characteristics of Rth is also within the scope of the invention.

The second optically-anisotropic layer may be formed of a cellulose acylate film. The cellulose acylate film for the second optically-anisotropic layer may be the same as the cellulose acylate film for the optical film to be used in fabricating the above-mentioned polarizer. In particular, preferred is a cellulose acylate film containing at least the above-mentioned Rth enhancer. More preferably, the film contains, as the Rth enhancer, at least one compound having an absorption peak within a range of from 250 nm to 380 nm.

The second optically anisotropic layer may be formed of a liquid crystal composition or any combination of such a layer and a polymer film. The liquid crystal composition comprises at least one liquid crystal compound. Preferably, the liquid crystal compound is selected from discotic liquid crystals having a discotic molecular structure. Preferred examples of the discotic liquid crystal compound include those described in Japanese Laid-open Patent Publication No. 2001-27706.

Preferably, the liquid crystal composition is curable, and comprises a polymerizable ingredient to form a layer by polymerization. The liquid crystal compound it self may be polymerizable or another polymerizable monomer may be added to the composition, and the former is preferred. The curable liquid crystal composition may comprise, if necessary, various additives such as a polymerization initiator, an alignment controlling agent and a surfactant.

The second optically anisotropic layer may be prepared as follows. A curable liquid crystal composition is prepared as a coating liquid, is applied to a surface of a support or an alignment layer. After molecules of the liquid crystal compound, preferably discotic liquid crystal compound, are aligned in a preferred alignment state, irradiated with light and/or heat to start the polymerization, and fixed in the state. And, the layer is prepared. For preparing the layer exhibiting the predetermined properties, which are required for the second optically anisotropic layer, preferably discotic molecules are aligned in a homeotropic alignment state, in which the angle between the optical axis of the discotic plane and the layer plane is orthogonal, and then fixed in the state.

Generally, a layer formed of a curable liquid crystal composition is disposed on a support such as a polymer film. In such embodiments, birefringence of the support such as a polymer film may be utilized actively, and the combination of the layer and support as a whole may exhibit the properties which are required for the second optically anisotropic layer. On the other hand, a polymer film of which Re is nearly equal to 0, such as those described in Japanese Laid-open Patent publication No. 2005-138375, may be used as a support, and the layer formed of the curable liquid crystal composition may have properties which are required for the second optically anisotropic layer alone.

### EXAMPLES

The invention is described more concretely with reference to the following Examples, in which the material and the reagent used, their amount and the ratio, the details of the treatment and the treatment process may be suitably modified or changed not overstepping the sprit and the scope of the invention. Accordingly, the invention should not be limited by the Examples mentioned below.

### [Optical Films (Films for First Optically-Anisotropic Layer) 101 to 105, 107 and 108]

The ingredients were mixed in the ratio indicated in Table 1, thereby preparing cellulose acylate solutions. Each of the cellulose acylate solution was cast, using a band caster, and the obtained web was peeled from the band, and thereafter this was stretched in the machine direction and in the transverse direction under the condition shown in Table 1. After stretched, the films were dried, thereby giving cellulose acylate films 101 to 105, 107 and 108 having a thickness shown in Table 1.

### [Optical Film (Film for First-Optically Anisotropic Layer) 106 of the Invention]

A commercial norbornene polymer film “ZEONOR” (by Nippon Zeon) was stretched under the condition shown in Table 1, thereby giving a norbornene film 106.

Thus produced, the films were analyzed for the three-dimensional birefringence thereof at a wavelength of 446 nm, 548 nm and 628 nm, using an automatic birefringence meter KOBRA-21WR (by Oji Scientific Instruments) according to the method mentioned in the above, thereby calculating the in-plane retardation Re and the thickness-direction retardation Rth based on the data of Re at different inclined angles. Table 2 shows Re and Rth at different wavelengths. As in Table 2 below, it is understandable that the films 101 to 108 are all biaxial films, but the film 106 is an optical film outside the scope of the invention since its Re and Rth increase with a shorter wavelength.

The surface of each optically-compensatory film produced in the above was saponified with alkali. Concretely, the film was dipped in an aqueous 1.5 N sodium hydroxide solution at 55° C. for 2 minutes, then washed in a water bath at room temperature, and neutralized with 0.1 N sulfuric acid at 30° C. Again this was washed in a water bath at room temperature, and then dried with hot air at 100° C.

TABLE 1

| | Film Sample No. | | | | | | | |
|---|---|---|---|---|---|---|---|---|
| | 101 | 102 | 103 | 104 | 105 | 106 | 107 | 108 |
| Polymer | cellulose | cellulose | cellulose | cellulose | cellulose | norbornene | cellulose | cellulose |
| material | acylate | acylate | acylate | acylate | acylate | based | acylate | acylate |
| | (Ac | (Ac | (Ac | (Ac | (Ac | polymer | (Ac | (Ac |
| | substitution | substitution | substitution | substitution | substitution | (ZEONOR) | substitution | substitution |
| | degree | degree | degree | degree | degree | | degree | degree |
| | 2.86) | 2.86) | 2.86) | 2.94) | 2.82) | | 2.86) | 2.95) |
| triphenyl | 7% | 7% | 7% | 7% | 7% | — | 7% | 4% |
| phosphate | | | | | | | | |
| (mass %) | | | | | | | | |
| biphenyl | 5% | 5% | 5% | 5% | 5% | — | 5% | 3% |
| phosphate | | | | | | | | |
| (mass %) | | | | | | | | |
| Retardation | 9% | 9% | 9% | 7% | 7% | — | 9% | 6% |
| enhancer 1 | | | | | | | | |
| (mass %) | | | | | | | | |
| Retardation | — | — | — | 2% | 1% | — | — | — |
| enhancer 2 | | | | | | | | |
| (mass %) | | | | | | | | |
| Retardation | — | — | — | 2% | 1% | — | — | 5% |
| enhancer 3 | | | | | | | | |
| (mass %) | | | | | | | | |
| Stretching | 160° C. | 160° C. | 160° C. | 160° C. | 160° C. | 140° C. | 160° C. | 170° C. |
| process | TD 20% | TD 20% | TD 20% | TD 25% | TD 20% | TD 30% | TD 20% | TD 30% |
| | stretching | stretching | stretching | stretching | stretching | stretching | stretching | stretching |
| thickness | 80 | 80 | 100 | 80 | 80 | 75 | 100 | 55 |
| (μm) | | | | | | | | |

*The amount (mass %) of the additive in the Table is based on the amount of cellulose acylate, 100 mass %.
Retardation Enhancer 1

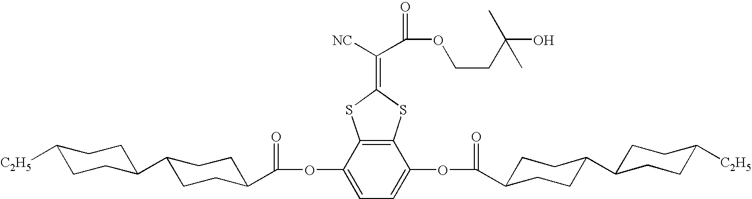

Retardation Enhancer 2

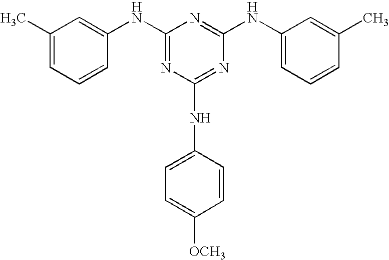

Retardation Enhancer 3

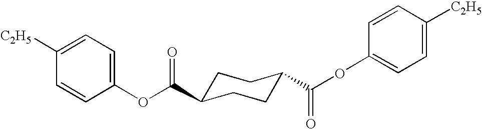

TABLE 2

| | | Film Sample No. | | | | | | | |
|---|---|---|---|---|---|---|---|---|---|
| | | 101 | 102 | 103 | 104 | 105 | 106 | 107 | 108 |
| Re (nm) | wavelength 446 nm | 82 | 90 | 102 | 98 | 63 | 105 | 132 | 89 |
| | wavelength 548 nm | 101 | 105 | 120 | 120 | 80 | 101 | 150 | 104 |
| | wavelength 628 nm | 115 | 109 | 125 | 126 | 90 | 100 | 161 | 109 |
| Rth (nm) | wavelength 446 nm | 103 | 99 | 113 | 85 | 140 | 127 | 134 | 104 |
| | wavelength 548 nm | 126 | 119 | 138 | 100 | 160 | 125 | 150 | 125 |
| | wavelength 628 nm | 144 | 126 | 146 | 106 | 171 | 123 | 160 | 131 |

### [Films for Second Optically-Anisotropic Layer]

The ingredients were mixed in the ratio indicated in Table 3, thereby preparing cellulose acylate solutions. Each of the cellulose acylate solutions was cast, using a band caster, and the obtained web was peeled from the band, and thereafter dried to give cellulose acylate films 201 to 205 and 209 having a thickness shown in Table 3.

### [Films for Second Optically-Anisotropic Layer 206 to 208]

Commercial films, TD80UL (by FUJIFILM), TF80UL (by FUJIFILM), TVD80SL D (by FUJIFILM) were used as polymer films for the second optically-anisotropic layer 206 to 208.

Thus produced, the films were analyzed for the three-dimensional birefringence thereof at a wavelength of 446 nm, 548 nm and 628 nm, using an automatic birefringence meter KOBRA-21WR (by Oji Scientific Instruments) according to the method mentioned in the above, thereby calculating the in-plane retardation Re and the thickness-direction retardation Rth based on the data of Re at different inclined angles. Table 4 shows Re and Rth at different wavelengths.

TABLE 3

| | Film Sample No. | | | | | | | | |
|---|---|---|---|---|---|---|---|---|---|
| | 201 | 202 | 203 | 204 | 205 | 206 | 207 | 208 | 209 |
| Polymer | cellulose | cellulose | cellulose | cellulose | cellulose | commercially- | commercially- | commercially- | cellulose |
| material | acylate | acylate | acylate | acylate | acylate | available | available | available | acylate |
| | (Ac | (Ac | (Ac | (Ac | (Ac | cellulose | cellulose | cellulose | (Ac |
| | substitution | substitution | substitution | substitution | substitution | acylate film | acylate film | acylate film | substitution |
| | degree | degree | degree | degree | degree | TD80UL | TF80UL | TVD80SLD | degree |
| | 2.92) | 2.82) | 2.86) | 2.86) | 2.92) | (produced by | (produced by | (produced by | 2.87) |
| triphenyl | 7% | 7% | 7% | 7% | — | FUJIFILM) | FUJIFILM) | FUJIFILM) | 7% |
| phosphate | | | | | | | | | |
| (mass %) | | | | | | | | | |
| biphenyl | 5% | 5% | 5% | 5% | — | | | | 5% |
| phosphate | | | | | | | | | |
| (mass %) | | | | | | | | | |
| Rth reducer | — | — | — | — | 5% | | | | — |
| (mass %) | | | | | | | | | |
| UV | 6% | — | — | 6% | 6% | | | | — |
| Absorbent 1 | | | | | | | | | |
| (mass %) | | | | | | | | | |
| UV | — | 2% | — | — | — | | | | — |
| Absorbent2 | | | | | | | | | |
| (mass %) | | | | | | | | | |
| Retardation | — | — | 2% | — | — | | | | 7% |
| enhancer 2 | | | | | | | | | |
| (mass %) | | | | | | | | | |
| thickness | 80 | 80 | 80 | 80 | 80 | 79 | 80 | 80 | 43 |
| (μm) | | | | | | | | | |

*The amount (mass %) of the additive in the Table is based on the amount of cellulose acylate, 100 mass %.
Rth Reducer

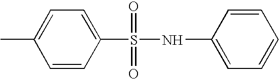

UV Absorbent 1

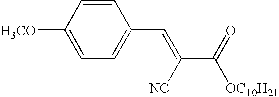

UV Absorbent 2

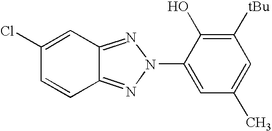

TABLE 4

| | | Film Sample No. | | | | | | | | |
|---|---|---|---|---|---|---|---|---|---|---|
| | | 201 | 202 | 203 | 204 | 205 | 206 | 207 | 208 | 209 |
| Re (nm) | wavelength | 3 | 2 | 1 | 4 | 3 | −3 | 1 | 4 | 6 |
| | 446 nm | | | | | | | | | |
| | wavelength | 2 | 2 | 0 | 2 | 2 | 2 | 1 | 8 | 5.7 |
| | 548 nm | | | | | | | | | |
| | wavelength | 1 | 1 | 0 | 1 | 2 | 4 | 2 | 10 | 5.4 |
| | 628 nm | | | | | | | | | |
| Rth | wavelength | 125 | 103 | 100 | 130 | 90 | 34 | 42 | 77 | 108 |
| (nm) | 446 nm | | | | | | | | | |
| | wavelength | 100 | 100 | 100 | 120 | 85 | 42 | 48 | 82 | 105 |
| | 548 nm | | | | | | | | | |
| | wavelength | 95 | 98 | 100 | 115 | 83 | 45 | 51 | 86 | 104 |
| | 628 nm | | | | | | | | | |

The surface of each optical film produced in the above was saponified with alkali. Concretely, the film was dipped in an aqueous 1.5 N sodium hydroxide solution at 55° C. for 2 minutes, then washed in a water bath at room temperature, and neutralized with 0.1 N sulfuric acid at 30° C. Again this was washed in a water bath at room temperature, and then dried with hot air at 100° C.

[Production of Polarizing film 301R and Comparative Polarizing Plates Comprising it]

A PVA film having a mean degree of polymerization of 2400 and a thickness of 75 μm was pre-swollen in ion-exchanged water at 15° C. for 48 seconds, then wiped with a stainless blade to remove the surface water, and thereafter the resulting PVA film was dipped in an aqueous solution (dyeing solution) of iodine (0.8 g/L) and potassium iodide (60.0 g/L) with concentration correction so as to keep a constant concentration, at 40° C. for 55 seconds, and further the PVA film was dipped in an aqueous solution (hardening solution) of boric acid (42.5 g/L) and potassium iodide (30 g/L) still with concentration correction so as to keep a constant concentration, at 40° C. for 90 seconds, and then stretched by 5.3 times, thereby giving a polarizing film 301R. The thickness of the polarizing film 301R was 32 μm.

Next, using an aqueous solution of 3% PVA (Kuraray's PVA-124H) as an adhesive, a commercial film TD80UL (by FUJIFILM, cellulose triacetate, in-plane retardation 3.0 nm, thickness 80 μm) that had been alkali-saponified in the same manner as above was stuck to the above saponified optical film in such a manner that the saponified surface could be on the side of the PVA film, and then heated at 75° C. for 10 minutes, thereby fabricating a polarizing plate as a roll, having an effective width of 650 nm and a length of 100 m. The polarizing plates thus produced are shown in Table 5.

### [Production of Polarizing Film 301 and Polarizing Plates Comprising it of the Invention]

A PVA film having a mean degree of polymerization of 2400 and a thickness of 50 μm was pre-swollen in water at 15° C. for 60 seconds, then the excess water was removed, and the resulting PVA film was dipped in an aqueous solution (dyeing solution) of iodine (1.0 g/L) and potassium iodide (60.0 g/L) with concentration correction so as to keep a constant concentration, at 40° C. for 70 seconds, and further this was stretched by 6.0 times in an aqueous solution (hardening solution) of boric acid (55.0 g/L), potassium iodide (30 g/L), C.I. Direct Yellow 44 (λmax 410 nm) (0.1 g/L) and C.I. Direct Blue 1 (λmax 650 nm) (0.1 g/L) still with concentration correction so as to keep a constant concentration, thereby giving a polarizing film 301. The thickness of the polarizing film 301 was 18 μm.

Next, in the same manner as that for the above comparative polarizing plate, a saponified commercial film TD80UL (by FUJIFILM) and the saponified optical film were stuck together, thereby fabricating a polarizing plate having an effective width of 1490 nm and a length of 3000 m. The polarizing plates thus produced are shown in Table 5.

### [Production of Polarizing Film 302 and Polarizing Plates Comprising it of the Invention]

A PVA film having a mean degree of polymerization of 2400 and a thickness of 75 μm was pre-swollen in water at 15° C. for 60 seconds, then the excess water was removed, and the resulting PVA film was dipped in an aqueous solution (dyeing solution) of iodine (1.2 g/L) and potassium iodide (60.0 g/L) with concentration correction so as to keep a constant concentration, at 40° C. for 65 seconds, and further this was stretched by 6.0 times in an aqueous solution (hardening solution) of boric acid (60.0 g/L) and potassium iodide (10 g/L) still with concentration correction so as to keep a constant concentration, thereby giving a polarizing film 302. The thickness of the polarizing film 302 was 26 μm.

Next, in the same manner as that for the above comparative polarizing plate, a saponified commercial film TD80UL (by FUJIFILM) and the saponified optical film were stuck together, thereby producing a polarizing plate having an effective width of 1490 nm and a length of 3000 m. The polarizing plates thus produced are shown in Table 2. Polarizing plates having an effective width of 1490 nm and a length of 3000 m were produced. The produced polarizing plates are shown in Table 5.

### [Performance Evaluation of Polarizing Plates]

### (1) Single Transmittance and Degree of Polarization:

The produced polarizing plates were analyzed with Shimadzu autospectrophotometer UV3100 (by Shimadzu).

Two of each of the polarizing plates were placed one upon another in a manner that their absorption axes were parallel to each other, and then the transmittance of the laminate H0(%) was measured; and they were placed in a manner that their absorption axes were perpendicular to each other, and then the transmittance of the laminate H1(%) was measured. The degree of polarization was calculated from the following formula. The data of the single transmittance and the degree of polarization were calculated by applying a luminosity correction.

Degree of polarization P=[(H0−H1)/(H0+H1)]^{1/2}×100 (1)

According to the invention, a polarizing plate having a degree of polarization P equal to or more than 99.9% is employed.

### (2) Transmittance Through a Pair of Crossed Polarizing Plates:

Two of each of the polarizing plates were placed one upon another in a manner that their absorption axes were crosses to each other, and the transmittance at 700 nm and 410 nm of the laminate was measured with Shimadzu autospectrophotometer UV3100 (by Shimadzu).

### [Construction of Liquid-Crystal Display Device]

A VA-mode liquid-crystal display device of FIG. 2 was constructed. Concretely, in a VA-mode liquid-crystal TV (DV3251, by Ben-Q), the polarizing plate and the retardation plate on both the top and the back of the panel were peeled away, and this was used as a liquid-crystal cell. In the constitution of FIG. 2, as polarizing plate P1, any one of polarizing plates, comprising a commercial film TD80UL as the outer protective film 16, any of the polarizing film 301R, 301 or 302 as the polarizing film 12, and any of the optical films 101 to 108 as the first optically-anisotropic layer 14, was used; the above VA-mode liquid crystal cell was used as the liquid-crystal cell 13; and as polarizing plate P2, any one of polarizing plates, comprising a commercial film TD80UL as the outer protective film 17, any of the polarizing film 301R, 301 or 302 as the polarizing film 11, and any of the optical films 201 to 209 as the second optically-anisotropic layer 15, was used. And these were combined, as indicated in Table 5, and stuck together with an adhesive; and then liquid-crystal display devices were produced.

The polarizing plate P1 was so disposed that the optical film (any one of films 101 to 108) was disposed on the side of the liquid-crystal cell 13; and the polarizing plate P2 was so disposed that the optical film (any one of films 201 to 209) was disposed on the side of the liquid-crystal cell 13.

### [Evaluation of Liquid-Crystal Display Device]

### (Evaluation of Viewing Angle-Dependent Color Shift on Panel)

Regarding each of the VA-mode liquid-crystal display devices produced in the above, in which a backlight was disposed on the side of polarizing plate P1 in FIG. 2, the brightness and the chromaticity in the black state or in the white state were measured in a dark room, using a tester (EZ-Contrast XL88 by ELDIM), and the color difference (color shift) between the color in the normal direction and that in a direction at a polar angle of 60° and an azimuth angle of 45° in the black state. In addition, the viewing angle range (within which the contrast ratio is equal to or more than 10) was determined.

The results are shown in Table 5 below.

### Color Shift in an Oblique Direction at a Polar Angle in a Black State:

In the black state, it is desirable that the difference between the chromaticity in the normal direction and the chromaticity in the oblique direction at the polar angle of 60 degrees, or that is, the angle inclined by 60 degrees against the normal direction of the LCD, and at the azimuth angle of 45 degrees, or that is, which is the direction of the centerline of the transmission axes of the pair of polarizing plates, Δx and Δy satisfy the following relation:

0≦[(Δx)²+(Δy)²]^{1/2}≦0.03.

### Viewing Angle:

The contrast represented by the ratio of white brightness and black brightness is preferably higher, and it is preferably higher within an overall viewing angle range in every oblique direction of the panel. Overall oblique viewing angle range means a range that covers the overall viewing angle direction at a polar angle ranging from 0 degree to 80 degrees relative to the normal direction of the liquid-crystal cell and at an azimuthal angle raging from 0 degree to 360 degrees relative to the centerline of the transmission axes of the pair of polarizing plates, the contrast is preferably equal to or more than 10.

TABLE 5

| | Polarizing Plate P1 | | | | | Polarizing Plate P2 | | | | | | |
|---|---|---|---|---|---|---|---|---|---|---|---|---|
| | First | | | | | Second | | | | | | |
| | Optically | | | | | Optically | | | | | Displaying Performance | |
| | Aniso- | Polar- | Polar- | Trans- | Trans- | Aniso- | Polar- | Polar- | Trans- | Trans- | | Difference |
| | tropic | izing | ization | mittance | mittance | tropic | izing | ization | mittance | mittance | Viewing | in |
| | Layer 14 | Film 12 | Degree | at 700 nm | at 410 nm | Layer 15 | Film 11 | Degree | at 700 nm | at 410 nm | Angle | Coloration*¹ |
| Invention | 101 | 301 | 99.97% | 0.05% | 0.02% | 201 | 301 | 99.97% | 0.05% | 0.02% | >80* | 0.03 |
| Invention | 101 | 302 | 99.96% | 0.07% | 0.05% | 201 | 302 | 99.96% | 0.07% | 0.05% | >80* | 0.04 |
| Invention | 101 | 301 | 99.97% | 0.05% | 0.02% | 202 | 301 | 99.97% | 0.05% | 0.02% | >80* | 0.04 |
| Invention | 101 | 302 | 99.96% | 0.07% | 0.05% | 202 | 302 | 99.96% | 0.07% | 0.05% | >80* | 0.04 |
| Invention | 101 | 301 | 99.97% | 0.05% | 0.02% | 203 | 301 | 99.97% | 0.05% | 0.02% | >80* | 0.03 |
| Invention | 101 | 302 | 99.96% | 0.07% | 0.05% | 203 | 302 | 99.96% | 0.07% | 0.05% | >80* | 0.04 |
| Invention | 102 | 301 | 99.97% | 0.05% | 0.02% | 201 | 301 | 99.97% | 0.05% | 0.02% | >80* | 0.04 |
| Invention | 102 | 302 | 99.96% | 0.07% | 0.05% | 201 | 302 | 99.96% | 0.07% | 0.05% | >80* | 0.04 |
| Invention | 103 | 301 | 99.97% | 0.05% | 0.02% | 201 | 301 | 99.97% | 0.05% | 0.02% | >80* | 0.03 |
| Invention | 103 | 302 | 99.96% | 0.07% | 0.05% | 201 | 302 | 99.96% | 0.07% | 0.05% | >80* | 0.04 |
| Invention | 104 | 301 | 99.97% | 0.05% | 0.02% | 204 | 301 | 99.97% | 0.05% | 0.02% | >80* | 0.04 |
| Invention | 104 | 302 | 99.96% | 0.07% | 0.05% | 204 | 302 | 99.96% | 0.07% | 0.05% | >80* | 0.04 |
| Invention | 105 | 301 | 99.97% | 0.05% | 0.02% | 205 | 301 | 99.97% | 0.05% | 0.02% | >80* | 0.05 |
| Invention | 105 | 302 | 99.96% | 0.07% | 0.05% | 205 | 302 | 99.96% | 0.07% | 0.05% | >80* | 0.05 |
| Invention | 105 | 301 | 99.97% | 0.05% | 0.02% | 206 | 301 | 99.97% | 0.05% | 0.02% | >80* | 0.05 |
| Invention | 105 | 302 | 99.96% | 0.07% | 0.05% | 206 | 302 | 99.96% | 0.07% | 0.05% | >80* | 0.05 |
| Invention | 105 | 301 | 99.97% | 0.05% | 0.02% | 207 | 301 | 99.97% | 0.05% | 0.02% | >80* | 0.05 |
| Invention | 105 | 302 | 99.96% | 0.07% | 0.05% | 208 | 302 | 99.96% | 0.07% | 0.05% | >80* | 0.05 |
| Invention | 105 | 301 | 99.96% | 0.05% | 0.10% | 208 | 301 | 99.96% | 0.05% | 0.02% | >80* | 0.05 |
| Invention | 105 | 302 | 99.96% | 0.07% | 0.10% | 208 | 302 | 99.96% | 0.07% | 0.05% | >80* | 0.05 |
| Invention | 108 | 301 | 99.97% | 0.05% | 0.02% | 209 | 301 | 99.97% | 0.05% | 0.02% | >80* | 0.03 |
| Comparative | 106 | 301 | 99.96% | 0.05% | 0.10% | 201 | 301 | 99.96% | 0.05% | 0.02% | 78* | 0.09 |
| Example | | | | | | | | | | | | |
| Comparative | 106 | 302 | 99.96% | 0.07% | 0.10% | 201 | 302 | 99.96% | 0.07% | 0.05% | 78* | 0.09 |
| Example | | | | | | | | | | | | |
| Comparative | 101 | 301R | 99.93% | 0.35% | 0.15% | 201 | 301R | 99.94% | 0.32% | 0.14% | 75* | 0.11 |
| Example | | | | | | | | | | | | |
| Comparative | 102 | 301R | 99.92% | 0.38% | 0.12% | 201 | 301R | 99.92% | 0.36% | 0.13% | 75* | 0.11 |
| Example | | | | | | | | | | | | |
| Comparative | 103 | 301R | 99.94% | 0.32% | 0.13% | 201 | 301R | 99.93% | 0.33% | 0.19% | 75* | 0.10 |
| Example | | | | | | | | | | | | |
| Comparative | 104 | 301R | 99.93% | 0.40% | 0.14% | 204 | 301R | 99.93% | 0.35% | 0.18% | 75* | 0.11 |
| Example | | | | | | | | | | | | |
| Comparative | 105 | 301R | 99.94% | 0.41% | 0.15% | 205 | 301R | 99.94% | 0.36% | 0.20% | 75* | 0.10 |
| Example | | | | | | | | | | | | |
| Comparative | 106 | 301R | 99.92% | 0.36% | 0.13% | 201 | 301R | 99.92% | 0.33% | 0.17% | 75* | 0.15 |
| Example | | | | | | | | | | | | |
| Comparative | 107 | 301R | 99.93% | 0.33% | 0.12% | 201 | 301R | 99.93% | 0.32% | 0.13% | 75* | 0.16 |
| Example | | | | | | | | | | | | |

*¹Color shift in the normal direction and in the direction at an azimuth angle 45° and a polar angle 60°.

From the results shown in Table 5, it is understandable that the polarizing plates of the invention have excellent optical compensatory performance in terms of hue and viewing angle range. Further, it is also understandable that use of the polarizing plate of the invention provides a VA-mode liquid-crystal display device having a widened viewing angle range and expressing good color.

Two other types of liquid-crystal display devices were produced and evaluated, comprising the optical film 107 as the first optically-anisotropic layer and the optical film 201 as the second optically-anisotropic layer and in which the polarizing film 301 and the polarizing film 302 were combined. Their panel display performance (viewing angle, color shift) was good; however, the liquid-crystal display devices with the optical films 101 to 105 and 108 each satisfying the above relations (7a) to (9a) as the first optically-anisotropic layer were better than the two devices in terms of displaying performance.

What is claimed is:

1. A polarizing plate comprising at least a polarizing film and an optical film, and
having a transmittance through a pair of crossed polarizing plates equal to or less than 0.3% at 700 nm and a transmittance through a pair of crossed polarizing plates equal to or less than 0.1% at 410 nm,
wherein the optical film has at least one optical axis in the plane thereof, and its in-plane retardation Re decreases with a shorter wavelength within a visible light range or is constant with a wavelength within a visible light range.

2. The polarizing plate of claim 1, having a degree of polarization P, as defined by the following formula, equal to or more than 99.95%:
Degree of polarization P=[(H0−H1)/(H0+H1)]^{1/2}×100
provided that H0 means the transmittance (%) through a pair of parallel polarizing plates and H1 means the transmittance (%) through a pair of crossed polarizing plates.

3. The polarizing plate of claim 1, which has a thickness equal to or less than 28 μm.

4. The polarizing plate of claim 1, wherein the optical film satisfies the following relations (a1) to (a6):
Re(548)>20 nm (a1)
0.5<Nz<10 (a2)
Re(446)/Re(548)≦1
1≦Re(628)/Re(548) (a4)
Rth(446)/Rth(548)≦1 (a5)
1<Rth(628)/Rth(548) (a6)
provided that Re(λ) and Rth(λ) each mean the in-plane and thickness-direction (unit: nm) of the film, as measured with light having a wavelength of λ nm applied thereto, and Nz=Rth(548)/Re (548)+0.5.

5. The polarizing plate of claim 4, wherein the optical film further satisfies the following relations (7a) to (9a):
−2.5×Re(548)+300<Rth(548)<−2.5×Re(548)+500 (7a)
−2.5×Re(446)+250<Rth(446)<−2.5×Re(446)+450 (8a)
−2.5×Re(628)+350<Rth(628)<−2.5×Re(628)+550. (9a)

6. The polarizing plate of claim 1, wherein the optical film is a cellulose acylate film.

7. The polarizing plate of claim 6, wherein the cellulose acylate film comprises an Re enhancer.

8. The polarizing plate of claim 7, wherein the Re enhancer comprises at least one compound represented by formula (I): 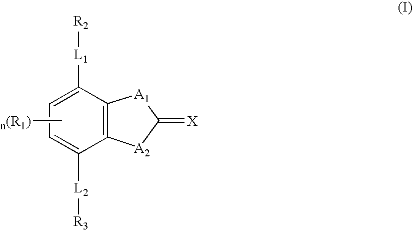
where, L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

9. The polarizing plate of claim 7, wherein the Re enhancer comprises at least two types of compounds.

10. The polarizing plate of claim 1, which has a width equal to or more than 1420 mm.

11. The polarizing plate of claim 1, which has a length equal to or more than 2000 m.

12. The polarizing plate of claim 1, wherein the thickness of the optical film is from 30 to 200 μm.

13. The polarizing plate of claim 1, further comprising a protective film on the surface of the polarizing film opposite to the surface thereof on which the optical film is disposed,
wherein a degree of moisture-permeation of the protective film is equal to or less than 300 g/(m²·day).

14. The polarizing plate of claim 13, wherein the protective film is a norbornene polymer film.

15. A liquid-crystal display device comprising a polarizing plate as set forth in claim 1, a liquid-crystal cell, and an optically-anisotropic layer satisfying the following relations (b1) and (b2):

|Rth(548)/Re(548)|>10 (b1)
Rth(628)−Rth(446)<0. (b2)

16. The liquid-crystal display device of claim 15, wherein the optically-anisotropic layer is a cellulose acylate film.

17. The liquid-crystal display device of claim 16, wherein the cellulose acylate film comprises an Rth enhancer.

18. The liquid-crystal display device of claim 17, wherein the Rth enhancer comprises at least one compound having an absorption peak at a wavelength within the range from 250 to 380 nm.

19. The liquid-crystal display device of claim 15, wherein the optically-anisotropic layer is or comprises a layer formed of a liquid crystal composition.

20. The liquid-crystal display device of claim 15, wherein the liquid-crystal cell is a vertically aligned-mode liquid-crystal cell.
